(19) United States
(12) Patent Application Publication
(10) Pub. No.: US 2026/0048659 A1
(43) Pub. Date: Feb. 19, 2026

(54) AUGMENTED-REALITY HEAD-UP DISPLAY FOR VEHICLE

(71) Applicant: Atieva, Inc., Newark, CA (US)

(72) Inventors: Arnaud Benedicte E. Gillard, San Francisco, CA (US); Isabelle Popescu Hoogland, San Jose, CA (US); David Wayne Flynt, Alameda, CA (US); Yunwei Yang, Foster City, CA (US)

(21) Appl. No.: 18/809,133

(22) Filed: Aug. 19, 2024

(51) Int. Cl. B60K 35/28; B60K 35/234

(52) U.S. Cl. CPC B60K 35/28; B60K 35/234; B60K 2360/177; B60K 2360/186; B60K 2360/191

(57) ABSTRACT

A method comprises: generating, by a navigation system of a vehicle, at least one navigation instruction to instruct a driver of the vehicle to make a turn at a location; presenting, using a head-up display (HUD) system of the vehicle, a HUD image on a windshield of the vehicle, the HUD image comprising augmented reality (AR) content including i) a turn symbol corresponding to the turn, and ii) a countdown indicator at least partially surrounding the turn symbol; updating the HUD image, before the vehicle reaches the location, so that the countdown indicator indicates a remaining time until the vehicle reaches the location; and updating the HUD image, after the vehicle reaches the location, so that the turn symbol rotates to indicate a direction of the turn.

### TECHNICAL FIELD

This disclosure relates to an augmented-reality (AR) head-up display (HUD) for a vehicle.

### BACKGROUND

Some attempts have been made in the automotive industry to design a windshield HUD in vehicles, typically to provide the driver with information related to the driving. These previous approaches have typically been associated with a small field of view (FOV), meaning that the restricted amount of information presented had only limited utility for driver guidance. Also, previous HUD systems have not successfully incorporated AR content to fully aid the driver in complex situations or maneuvers.

### SUMMARY

In a first aspect, a method comprises: generating, by a navigation system of a vehicle, at least one navigation instruction to instruct a driver of the vehicle to make a turn at a location; presenting, using a head-up display (HUD) system of the vehicle, a HUD image on a windshield of the vehicle, the HUD image comprising augmented reality (AR) content including i) a turn symbol corresponding to the turn, and ii) a countdown indicator at least partially surrounding the turn symbol; updating the HUD image, before the vehicle reaches the location, so that the countdown indicator indicates a remaining time until the vehicle reaches the location; and updating the HUD image, after the vehicle reaches the location, so that the turn symbol rotates to indicate a direction of the turn.

Implementations can include any or all of the following features. The turn symbol comprises an arrow. The arrow consists of a caret pointing in the direction of the turn. The arrow includes a shape that corresponds to an exit from a roundabout. The countdown indicator comprises a circular progress bar. At an end of the turn, the turn symbol is oriented vertically upward on the windshield. The turn symbol and the countdown indicator are positioned in a vertical AR plane of the HUD image, the HUD image further including a road surface AR plane that is substantially perpendicular to the vertical AR plane. The method further comprises presenting a grounding element in the road surface AR plane, wherein the grounding element corresponds to the turn symbol and the countdown indicator. The grounding element consists of a grounding dot in the road surface AR plane. The method further comprises presenting AR distance markers in the road surface AR plane. The AR distance markers are presented in the road surface AR plane a leading vehicle appears in front of the vehicle, the method further comprising switching from presenting the AR distance markers to instead presenting a two-dimensional (2D) view in the vertical AR plane, the 2D view including representations of the vehicle and the leading vehicle, and vertical distance markers between the representations of the vehicle and the leading vehicle. Updating the HUD image before the vehicle reaches the location comprises including progressively more details in the AR content as the vehicle approaches the location. Initially the AR content includes only the countdown indicator and not the turn symbol, and wherein updating the HUD image before the vehicle reaches the location further comprises adding the turn symbol to the AR content. Updating the HUD image before the vehicle reaches the location further comprises making the AR content larger on the windshield as the vehicle approaches the location. Updating the HUD image after the vehicle reaches the location further comprises also including a target symbol in the AR content, wherein the turn symbol remains stationary on the windshield, and wherein the target symbol moves horizontally on the windshield to indicate a target of the turn. The target symbol includes a target dot. The target symbol moves horizontally out of the HUD image during the turn, the method further comprising also including a target offscreen indicator in the AR content, the target offscreen indicator indicating that the target is outside the HUD image. The target offscreen indicator includes an arrow pointing toward the target. At an end of the turn, the target symbol merges with the turn symbol. The AR content further includes a 2D cluster with information. The method further comprises: determining a contrast ratio between the 2D cluster and a color of background against which the 2D cluster is to be presented; and in response to the contrast ratio not meeting a sufficiency criterion, changing a color of the 2D cluster based on the color of background. The method further comprises presenting longitudinal lines in the HUD image, the longitudinal lines indicating a width of the vehicle. The method further comprises dynamically occluding at least a portion of the longitudinal lines based on presence of a first object in front of the vehicle. Dynamically occluding the portion of the longitudinal lines comprises: dynamically creating a mask corresponding to a shape of the first object; and occluding the portion of the longitudinal lines using the mask, wherein the portion of the longitudinal lines is not visible in the HUD image. The method further comprises: detecting presence of a second object is positioned across at least one of the longitudinal lines; and in response to the detection, changing a color of the at least one of the longitudinal lines to indicate the presence of the second object. The method further comprises: determining a present location of the vehicle; identifying, using a map, an upcoming road turn based on the present location, the upcoming road turn associated with a maximum turn speed; and in response to a current speed of the vehicle exceeding the maximum turn speed, presenting a warning to the driver. The turn symbol and the countdown indicator are among multiple navigation symbols concurrently presented in the HUD image, the method further comprising blurring a first navigation symbol of the multiple navigation symbols. The multiple navigation symbols are associated with different distances from a current location of the vehicle, and wherein the first navigation symbol is closest to the vehicle of the multiple navigation symbols. A leading vehicle is traveling ahead of the vehicle and is detected using a radar detector, the leading vehicle being currently not visible from the vehicle due to road conditions, the method further comprising presenting a vehicle marker in the HUD image, the vehicle marker indicating a position of the leading vehicle. The method further comprises presenting longitudinal lines in the HUD image, the longitudinal lines indicating a width of the vehicle.

In a second aspect, a method comprises: generating, by a navigation system of a vehicle, at least one navigation instruction to instruct a driver of the vehicle to make a turn at a location; presenting, using a head-up display (HUD) system of the vehicle, a HUD image on a windshield of the vehicle, the HUD image comprising augmented reality (AR) content including a turn symbol corresponding to the turn; and updating the HUD image, after the vehicle reaches the location, to also include a target symbol, wherein the turn symbol remains stationary on the windshield, and wherein the target symbol moves in a substantially horizontal direction on the windshield to indicate a target of the turn.

Implementations can include any or all of the following features. The turn symbol comprises an arrow. The arrow consists of a caret pointing in the direction of the turn. The arrow includes a shape that corresponds to an exit from a roundabout. The method further comprises presenting a countdown indicator in the HUD image, the countdown indicator at least partially surrounding the turn symbol. The countdown indicator comprises a circular progress bar. Updating the HUD image before the vehicle reaches the location comprises including progressively more details in the AR content as the vehicle approaches the location. Initially the AR content includes only the countdown indicator and not the turn symbol, and wherein updating the HUD image before the vehicle reaches the location further comprises adding the turn symbol to the AR content. At an end of the turn, the turn symbol is oriented vertically upward on the windshield. The turn symbol and the target symbol are positioned in a vertical AR plane of the HUD image, the HUD image further including a road surface AR plane that is substantially perpendicular to the vertical AR plane. The method further comprises presenting a grounding element in the road surface AR plane, wherein the grounding element corresponds to the turn symbol. The grounding element consists of a grounding dot in the road surface AR plane. The method further comprises presenting AR distance markers in the road surface AR plane. While the AR distance markers are presented in the road surface AR plane a leading vehicle appears in front of the vehicle, the method further comprising switching from presenting the AR distance markers to instead presenting a two-dimensional (2D) view in the vertical AR plane, the 2D view including representations of the vehicle and the leading vehicle, and vertical distance markers between the representations of the vehicle and the leading vehicle. Updating the HUD image before the vehicle reaches the location further comprises making the AR content larger on the windshield as the vehicle approaches the location. The target symbol includes a target dot. The target symbol moves in the substantially horizontal direction to an area outside the HUD image during the turn, the method further comprising also including a target offscreen indicator in the AR content, the target offscreen indicator indicating that the target is outside the HUD image. The target offscreen indicator includes an arrow pointing toward the target. At an end of the turn, the target symbol merges with the turn symbol. The AR content further includes a 2D cluster with information. The method further comprises: determining a contrast ratio between the 2D cluster and a color of background against which the 2D cluster is to be presented; and in response to the contrast ratio not meeting a sufficiency criterion, changing a color of the 2D cluster based on the color of background. The method further comprises presenting longitudinal lines in the HUD image, the longitudinal lines indicating a width of the vehicle. The method further comprises dynamically occluding at least a portion of the longitudinal lines based on presence of a first object in front of the vehicle. Dynamically occluding the portion of the longitudinal lines comprises: dynamically creating a mask corresponding to a shape of the first object; and occluding the portion of the longitudinal lines using the mask, wherein the portion of the longitudinal lines is not visible in the HUD image. The method further comprises: detecting presence of a second object is positioned across at least one of the longitudinal lines; and in response to the detection, changing a color of the at least one of the longitudinal lines to indicate the presence of the second object. The method further comprises: determining a present location of the vehicle; identifying, using a map, an upcoming road turn based on the present location, the upcoming road turn associated with a maximum turn speed; and in response to a current speed of the vehicle exceeding the maximum turn speed, presenting a warning to the driver. The turn symbol and the target symbol are among multiple navigation symbols concurrently presented in the HUD image, the method further comprising blurring a first navigation symbol of the multiple navigation symbols. The multiple navigation symbols are associated with different distances from a current location of the vehicle, and wherein the first navigation symbol is closest to the vehicle of the multiple navigation symbols. A leading vehicle is traveling ahead of the vehicle and is detected using a radar detector, the leading vehicle being currently not visible from the vehicle due to road conditions, the method further comprising presenting a vehicle marker in the HUD image, the vehicle marker indicating a position of the leading vehicle. The method further comprises presenting longitudinal lines in the HUD image, the longitudinal lines indicating a width of the vehicle.

### BRIEF DESCRIPTION OF DRAWINGS

FIG. 1 shows an example of a HUD image including AR content.

FIG. 2 shows an example of a vehicle for which the HUD image of FIG. 1 can be generated.

FIG. 3 schematically shows an example of the vehicle of FIG. 2 and a virtual image generated by a HUD system of the vehicle.

FIG. 4 shows an example of a windshield of a vehicle.

FIG. 5 shows another example of the windshield of FIG. 4.

FIG. 6 shows another example of the windshield of FIG. 4.

FIG. 7 shows another example of the windshield of FIG. 4.

FIG. 8 shows an example of a HUD image.

FIG. 9 shows an example of a two-dimensional (2D) cluster that can be presented in a HUD image.

FIG. 10A shows an example of a HUD image with the 2D cluster of FIG. 9.

FIG. 10B shows another example of the HUD image with the 2D cluster of FIG. 9.

FIG. 11A shows an example of a HUD image with the 2D cluster of FIG. 9.

FIG. 11B shows another example of the HUD image with the 2D cluster of FIG. 9.

FIG. 11C shows another example of the HUD image with the 2D cluster of FIG. 9.

FIG. 12 shows an example of a HUD image presented during poor visibility.

FIG. 13 shows an example of a HUD image that can warn a driver of lane intrusions.

FIG. 14 schematically shows an example of a vehicle and active object detection.

FIG. 15 shows an example of a HUD image with AR content that can warn about speed ahead of an upcoming road turn.

FIG. 16 shows an example of turn guidance stages.

FIG. 17A shows an example of a HUD image with AR content.

FIG. 17B shows an example of the HUD image where some of the AR content is blurred.

FIG. 18A shows an example of a HUD image with AR content for navigation.

FIG. 18B shows another example of the HUD image with the AR content.

FIG. 18C shows another example of the HUD image with the AR content.

FIG. 18D shows another example of the HUD image with the AR content.

FIG. 18E shows another example of the HUD image with the AR content.

FIG. 18F shows another example of the HUD image with the AR content.

FIG. 18G shows another example of the HUD image with the AR content.

FIG. 18H shows another example of the HUD image with the AR content.

FIG. 18I shows another example of the HUD image with the AR content.

FIG. 19A shows an example of a HUD image with AR content for navigation.

FIG. 19B shows another example of the HUD image with the AR content.

FIG. 19C shows another example of the HUD image with the AR content.

FIG. 19D shows another example of the HUD image with the AR content.

FIG. 19E shows another example of the HUD image with the AR content.

FIG. 19F shows another example of the HUD image with the AR content.

FIG. 20A schematically shows an example relating to a turn symbol and a target symbol that can be presented as AR content in a HUD image.

FIG. 20B shows another example relating to the turn symbol and the target symbol of FIG. 20A.

FIG. 21 schematically shows an example relating to AR content that can be presented in a HUD image.

FIG. 22A schematically shows an example of content zones.

FIG. 22B shows examples of AR content that can be presented at the respective content zones of FIG. 22A.

FIG. 23 shows an example of a HUD image with AR content relating to navigation.

FIG. 24 shows an example of a HUD image for which critical zones have been defined.

FIG. 25A schematically shows an example of vehicles and AR content with and without dynamic occlusion.

FIG. 25B shows an example of a mask that can be used to provide the dynamic occlusion of FIG. 25A.

FIG. 26A schematically shows an example relating to switching between presenting AR content and a 2D view.

FIG. 26B schematically shows another example relating to switching between presenting the AR content and the 2D view.

FIG. 26C schematically shows another example relating to switching between presenting the AR content and the 2D view.

FIG. 27A schematically shows an example relating to switching between presenting AR content and a 2D view.

FIG. 27B schematically shows another example relating to switching between presenting the AR content and the 2D view.

FIG. 28 shows an example of a HUD system.

FIG. 29 shows an example of a passenger compartment of a vehicle with a windshield where a HUD image can be presented.

FIG. 30 shows an example of a driver assistance system.

FIG. 31 shows an example of a vehicle.

FIG. 32 illustrates an example architecture of a computer system.

Like reference symbols or numerals in the various drawings indicate like elements.

### DETAILED DESCRIPTION

The present disclosure provides examples of systems and methods of HUD systems presenting AR content for a driver of a vehicle. The HUD image with the AR content can support the driver in controlling the vehicle during navigation or other driving maneuvers. Each example described herein can be used with one or more other examples described elsewhere herein unless otherwise indicated.

Examples described herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether or to what extent the person is driving the vehicle, or whether the person has access to all or only some of the controls for driving the vehicle, or whether the person lacks controls for driving the vehicle. The term windshield refers to a transparent pane (e.g., flat or curved) that is positioned at least in front of the front-row occupant(s). For example, a windshield can continuously extend above the front-row seats and be part of a roof of the vehicle.

Examples described herein refer to a sensor. As used herein, a sensor is configured to detect one or more aspects of its environment and output signal(s) reflecting the detection. The detected aspect(s) can be static or dynamic at the time of detection. As illustrative examples only, a sensor can indicate one or more of a distance between the sensor and an object, a speed of a vehicle carrying the sensor, a trajectory of the vehicle, or an acceleration of the vehicle. A sensor can generate output without probing the surroundings with anything (passive sensing, e.g., like an image sensor that captures electromagnetic radiation), or the sensor can probe the surroundings (active sensing, e.g., by sending out electromagnetic radiation and/or sound waves) and detect a response to the probing. Examples of sensors that can be used with one or more embodiments include, but are not limited to: a light sensor (e.g., a camera); a light-based sensing system (e.g., a light ranging and detection (LiDAR) device); a radio-based sensor (e.g., radar); an acoustic sensor (e.g., an ultrasonic device and/or a microphone); an inertial measurement unit (IMU) (e.g., a gyroscope and/or accelerometer); a speed sensor (e.g., for the vehicle or a component thereof); a location sensor (e.g., for the vehicle or a component thereof); an orientation sensor (e.g., for the vehicle or a component thereof); a torque sensor; a thermal sensor; a temperature sensor (e.g., a primary or secondary thermometer); a pressure sensor (e.g., for ambient air or a component of the vehicle); a humidity sensor (e.g., a rain detector); or a seat occupancy sensor.

Examples described herein refer to a navigation instruction that instructs a driver of a vehicle to make a turn at a location. As used herein, a turn at a location includes any steering maneuver that the navigation system tells or recommends the driver to perform. Examples of turns include, but are not limited to: i) at a road intersection, turning from a first road onto a second road that crosses the first road; ii) at a branch where a road splits into multiple roads, taking one of the multiple roads; iii) at a highway exit, turning from the highway onto the exit road; iv) at a highway exit, remaining on the highway without taking the exit road; v) on a highway onramp, merging onto the highway; vi) changing from one lane to another of a road; vii) swaying or veering to avoid an object, or viii) picking one of multiple charging stations for an electric vehicle.

Examples described herein refer to a road. As used herein, a road includes any surface where a vehicle can be driven. A road has a roadway surface on which one or more lanes can be defined. A road can permit traffic to travel in one or more directions. Examples of roads include, but are not limited to: freeways, highways, streets, avenues, boulevards, alleys, roundabouts, bridges, causeways, racetracks, parkways, paths, or lanes.

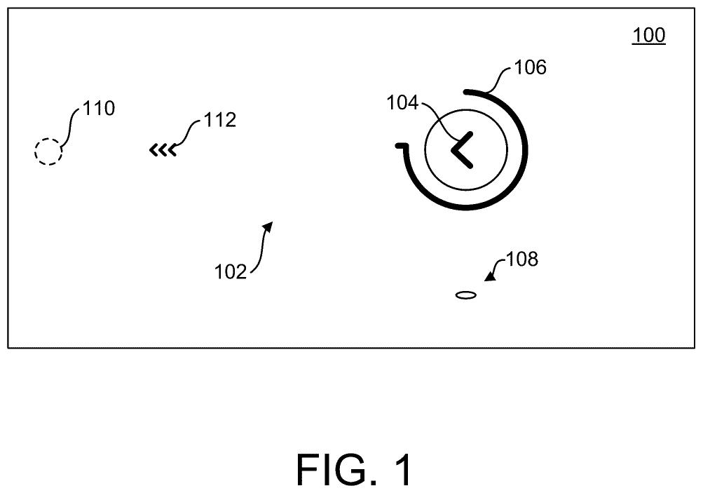

FIG. 1 shows an example of a HUD image 100 including AR content 102. The HUD image 100 and the AR content 102 can be presented, on a windshield of a vehicle, by a HUD system of the vehicle. The AR content 102 can include a turn symbol 104 corresponding to a turn that a navigation system is instructing the driver to make. That is, the vehicle is not currently being operated in a fully autonomous mode; rather, the driver is expected to perform the steering maneuver(s) necessary to bring the vehicle to the target destination defined in the navigation system. In some implementations, the turn symbol 104 can include an arrow that points in the direction that the driver should steer the vehicle for making the turn. For example, the arrow can consist of a caret pointing in the direction of the turn (here, toward the left in the illustration).

The AR content 102 can include a countdown indicator 106 that at least partially surrounding the turn symbol 104. In some implementations, the countdown indicator 106 comprises a circular progress bar. For example, the circular progress bar can progressively be filled or removed (or change color) in a clockwise direction until the countdown is complete.

The AR content 102 can include a grounding element 108 that here corresponds to the turn symbol 104 and the countdown indicator 106. The grounding element 108 can help the driver perceive the position of AR content (such as the turn symbol 104 or the countdown indicator 106) relative to the spatial characteristics of the physical surroundings of the vehicle against which the AR content is presented. For example, the grounding element 108 can help the driver understand how “far away” the AR content is from the vehicle's current position. When a road surface AR plane is defined in the HUD image 100, the grounding element 108 can be presented in the road surface AR plane. In some implementations, the grounding element 108 can be a grounding dot presented in relation to the turn symbol 104 or the countdown indicator 106. The grounding dot is not merely a drop shadow generated from the AR content but rather is a smart element that has a purpose in the context of driver guidance.

The AR content 102 can include a target symbol 110 that corresponds to a target of the turn that the driver is being instructed to make. The target symbol 110 can help the driver understand where the vehicle is supposed to be traveling, and thereby aid the driver's steering maneuvers. In some implementations, the target symbol 110 includes a circular element (e.g., a target dot).

Examples described below will illustrate that the target symbol 110 can originally be presented at a location inside the countdown indicator 106 and/or partially overlapping the turn symbol 104, and from that location can move in a substantially horizontal direction in the HUD image 100. The target symbol 110 represents a location of a target in the physical environment towards which the vehicle should travel. Depending on the nature of the turn, the target symbol 110 either remains inside the HUD image 100 during the entire turn (that is, remains visible to the user) or can move out of the HUD image 100 one or more times during the turn (during which time(s) the target symbol 110 is not visible to the user).

The AR content 102 can include a target offscreen indicator 112 indicating that the target is outside the HUD image. That is, when the target in the physical environment is not visible in the area of the HUD image 100 but rather is outside the HUD image 100, the target symbol 110 can temporarily move outside of the HUD image 100. The target offscreen indicator 112 can then indicate the direction towards where the target (the target symbol 110) currently is located. In some implementations, the target offscreen indicator 112 can include an arrow pointing toward the target.

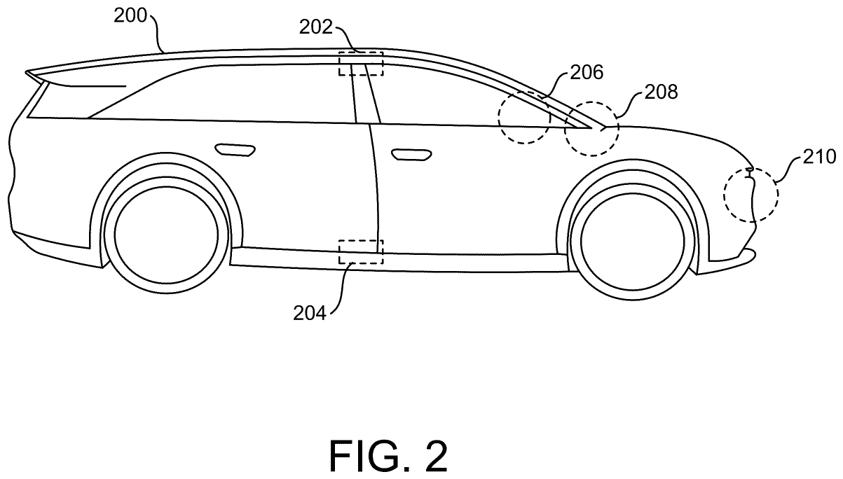

FIG. 2 shows an example of a vehicle 200 for which the HUD image 100 of FIG. 1 can be generated. The vehicle 200 can include a HUD system for presenting the HUD image 100, a navigation system for defining one or more turns, and one or more types of sensor to generate the signal(s) for the HUD system and/or the navigation system. Here, the vehicle 200 includes a global positioning system (GPS) receiver 202 that can be used for determining a current position of the vehicle 200. Here, the vehicle 200 includes an IMU 204 that can be used for performing ground plane estimation (e.g., for defining a road surface AR plane) and/or for motion adjustment. For example, the IMU 204 can include an accelerometer. Here, the vehicle 200 includes a camera 206 for a driver monitoring system (DMS) that can monitor behavior of the driver for safety purposes (e.g., perform eye tracking) and/or facilitate accurate positioning of AR content on the windshield (e.g., to adapt to drivers of different heights). For example, the camera 206 can be mounted in a steering wheel of the vehicle 200. Here, the vehicle 200 includes a light sensor 208 that can be used for automatically controlling headlight brightness.

Here, the vehicle 200 includes a camera 210 that can also or instead be used for ground plane detection and/or contrast detection (e.g., as described in examples below). For example, the camera 210 can be mounted in a front bumper of the vehicle 200. In some implementations, the camera 210 is a surround view monitor (SVM) camera. The SVM camera can have a significantly wider field of view (FOV) than another camera that is also part of the perception sensors for a driver assistance system of the vehicle 200. For example, the image generated by the SVM can be dewarped before being used in the processing that is the basis for providing a HUD image with AR content.

Generally, the driver assistance system of the vehicle 200 can leverage map data to learn and take into account the shape of the road in front of the vehicle 200. Such information can be combined with output of one or more other perception sensors, including, but not limited to, LiDAR and/or radar. In some implementations, navigation can be performed based on map information and camera perception. For example, three-dimensional (3D) coordinates can be obtained from the navigation system which tells the driver assistance how far away the vehicle 200 is from a given location. Camera perception can be used for providing a stable experience. For example, when the vehicle 200 travels over a speed bump, its nose (where the camera 210 may be positioned) moves up and down. This movement can be counteracted based on camera perception.

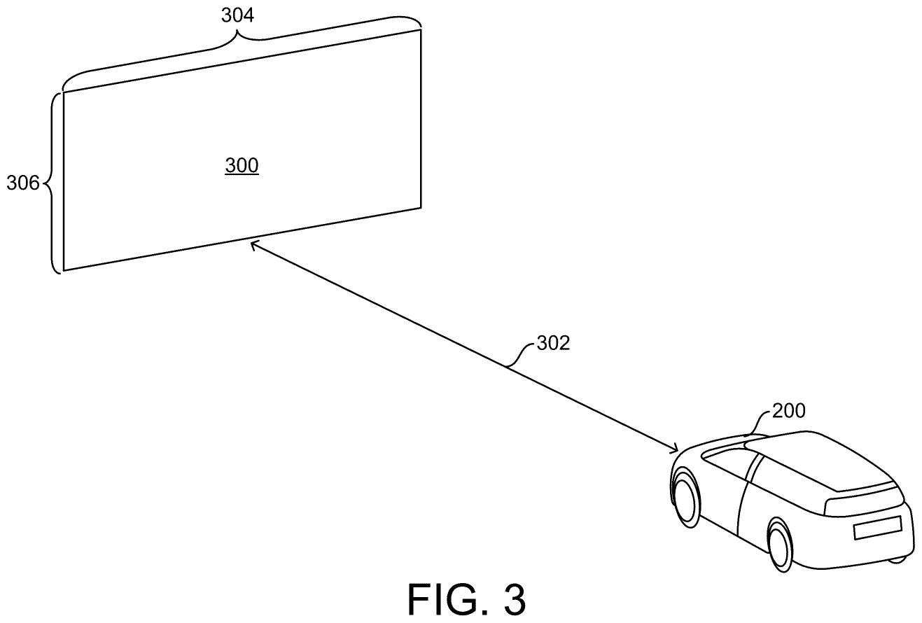

FIG. 3 schematically shows an example of the vehicle 200 of FIG. 2 and a virtual image 300 generated by a HUD system of the vehicle 200. The virtual image 300 is here illustrated as being positioned at a distance 302 from the vehicle 200, the distance 302 being perceived by the driver (or other occupant) when viewing the HUD image that is presented on the windshield of the vehicle 200. That is, the distance 302 can make it seem as if the AR content of the HUD image is placed in the real world. As a result, the driver need not continuously adjust their eyes' focus between far and near. The distance 302 can ensure that a slight head movement by the driver results in an essentially imperceptible impact on the AR content. The virtual image 300 can have a width 304 and a height 306. For example, the width 304 can be about 20-25% of the distance 302. As another example, the height 306 can be about 8-12% of the distance 302. Other proportions can be used.

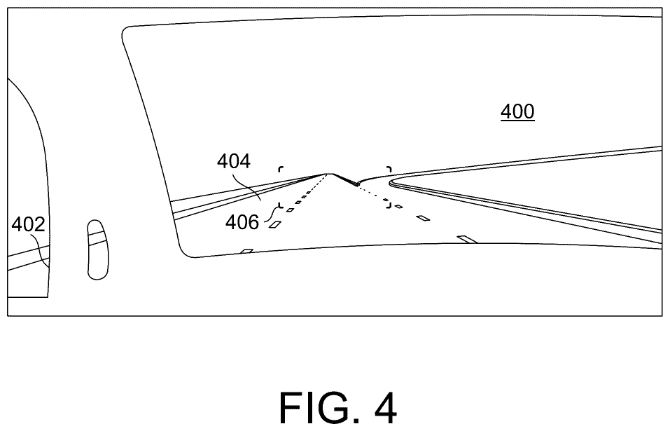

FIG. 4 shows an example of a windshield 400 of a vehicle 402. The windshield 400 is here shown in part, from a perspective inside the vehicle 402. The vehicle 402 is currently traveling along a road 404 which is visible to the driver through the windshield 400. A HUD projection area 406 is schematically illustrated on the windshield 400 in form of a rectangular shape defined by four brackets. The HUD projection area 406 corresponds to the FOV of the HUD system. That is, the HUD projection area 406 is the portion of the windshield 400 on which the HUD image can be projected to allow the driver to see the virtual image 300.

FIG. 5 shows another example of the windshield 400 of FIG. 4. This illustration corresponds to a closer view, so the HUD projection area 406 and the road 404 here appear larger than before. A HUD image can be projected in the HUD projection area 406. In some implementations, the HUD image can include a 2D cluster area 500, here shown as a rectangular shape for illustrative purposes. The cluster area 500 can be considered fixed within the HUD image and can be used for non-AR content. For example, the 2D cluster area 500 can include content that is not required to be presented in a physical context. When no high-value content is currently presented in the 2D cluster area 500, the 2D cluster area 500 can be repurposed to show information that the driver would otherwise have to shift focus to see. For example, vehicle speed, text, or icons from a driver assistance system can be presented in the 2D cluster area 500.

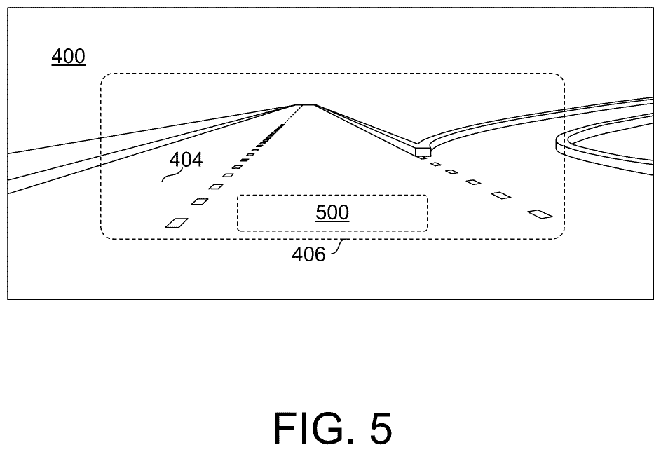

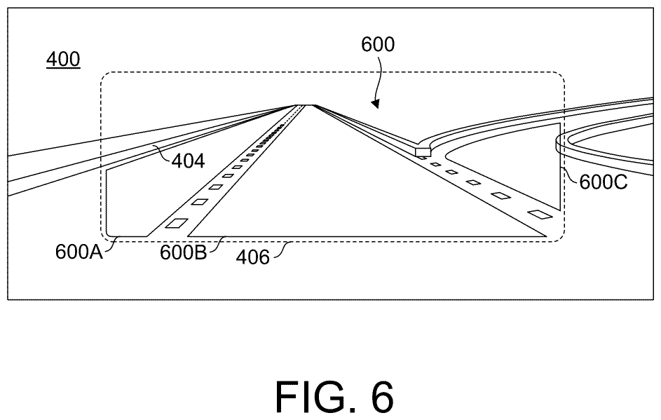

FIG. 6 shows another example of the windshield 400 of FIG. 4. The HUD projection area 406 here includes road surface AR planes 600. The road surface AR planes 600 can include one or more components. For example, a road surface AR plane 600A can correspond to a road surface in an adjacent lane to the vehicle. As another example, a road surface AR plane 600B can correspond to a road surface of a current lane of the vehicle. As another example, a road surface AR plane 600C can correspond to a road surface of an exit ramp from the road 404. The road surface AR planes 600 can be designated for content that confidently remains within the FOV as the vehicle travels. For example, driver assistance feature or safety-related features can be presented in the road surface AR planes 600. Obscuration of presented AR content can take priority to maintain realism. For example, if a driver assistance feature such as an AR lane line is slated for presentation where it would overlap a real-world object (e.g., another vehicle) then obscuration of the AR content can be performed so that the AR content is only presented in a credible fashion (e.g., with no unrealistic overlap). The road surface AR planes 600 can be defined based on sensor output that indicates where the road surface is located.

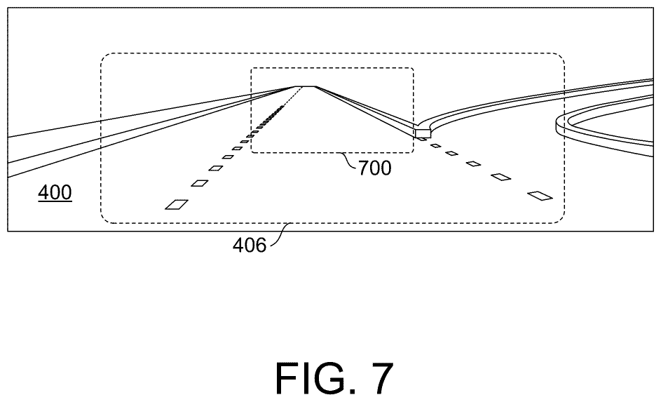

FIG. 7 shows another example of the windshield 400 of FIG. 4. The HUD projection area 406 here includes a vertical AR plane 700. The vertical AR plane 700 can be positioned in 3D and can retain its AR position in the real world. The vertical AR plane 700 can be used for AR content that is designated to override occlusion of AR content and ensure visibility of critical pieces of information. For example, navigation or warnings can be presented in the vertical AR plane 700. The vertical AR plane 700 can be substantially perpendicular to the road surface AR planes 600 of FIG. 6.

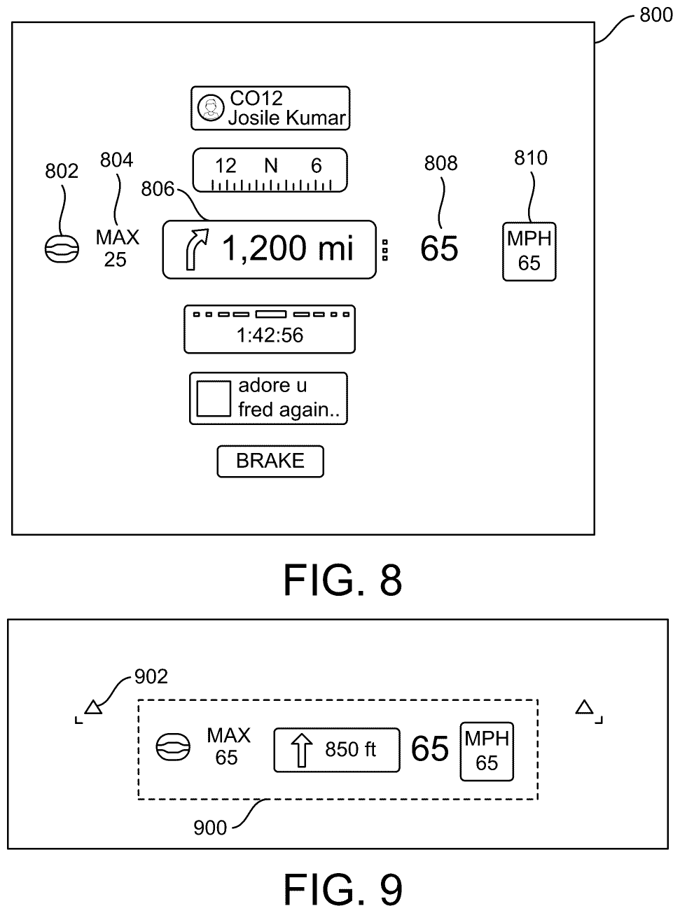

FIG. 8 shows an example of a HUD image 800. The information in the HUD image 800 can be, or be part of, a 2D cluster. Here, the information includes a driver assistance symbol 802 (e.g., that is highlighted when driver assistance is active); a driver assistance speed limit symbol 804 (e.g., to indicate the current setting of maximum speed for assisted driving); navigation instructions 806 (e.g., to indicate the next turn for the driver to make, and the distance to it); a current speed 808 of the vehicle; and a speed limit 810 of the road where the vehicle is traveling. The HUD system can feature a scalable architecture in which the navigation instructions 806 can be configured to be replaced in the HUD image 800 by any of multiple widgets for other types of content. For example, the navigation instructions 806 can be replaced by phone caller information, a compass, a clock, media player information, or instruction to the driver. The 2D cluster information can be presented in a way that is respective to driving modes (e.g., track racing, off-roading, urban driving) and conditions outside the vehicle (e.g., when driving at night). For example, the clock can be a widget for track mode whereby a user can easily access key pieces of information based on their driving mode and focus.

FIG. 9 shows an example of a two-dimensional (2D) cluster 900 that can be presented in a HUD image. The 2D cluster 900 can include any or all information exemplified with regard to the HUD image 800 of FIG. 8. Optionally, one or more warning symbols 902 (e.g., of an obstruction in an adjacent lane) can be presented with the 2D cluster 900.

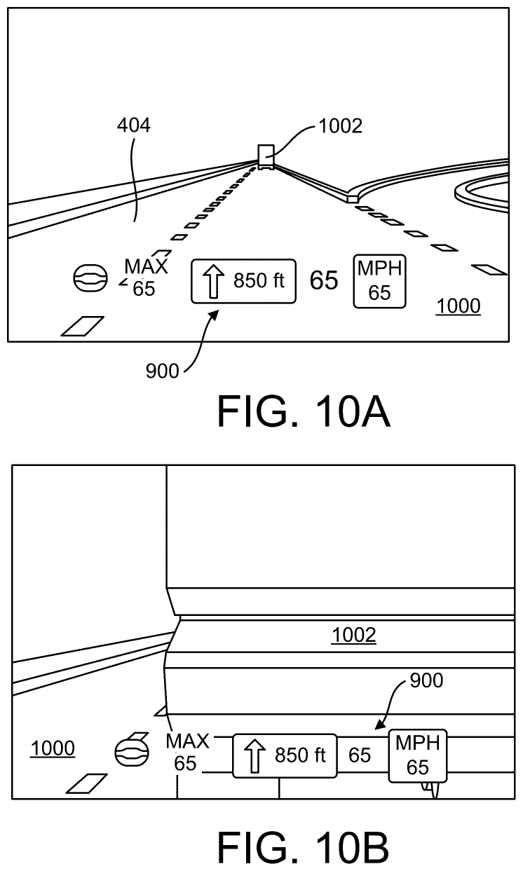

FIG. 10A shows an example of a HUD image 1000 with the 2D cluster 900 of FIG. 9. A vehicle 1002 is present ahead of the vehicle. The HUD system can use an exterior camera to monitor the outside environment and automatically change colors of content in a HUD image if contrast ratios are deemed insufficient. The HUD system can determine (e.g., using a camera or other light sensor) that the current background where the 2D cluster 900 is presented is the road 404. For example, the 2D cluster 900 does not currently overlap with the vehicle 1002. In response to that determination, the HUD system can present the 2D cluster 900 using a first color or other shade, based on whether a color ratio meets (or does not meet) a sufficiency criterion. For example, when the road 404 has a relatively dark color, the 2D cluster 900 can be presented using a light (e.g., white) color in the HUD image.

FIG. 10B shows another example of the HUD image 1000 with the 2D cluster 900 of FIG. 9. The HUD system can determine (e.g., using a camera or other light sensor) that the current background where the 2D cluster 900 is presented is the vehicle 1002 (e.g., not the road 404, as in FIG. 10A). That is, the 2D cluster 900 currently overlaps at least in part with the vehicle 1002. In response to that determination, the HUD system can present the 2D cluster 900 using a second color or other shade different from the first color/shade, based on whether a color ratio meets (or does not meet) a sufficiency criterion. For example, when the vehicle 1002 has a relatively light color, the 2D cluster 900 can be presented using a dark (e.g., black) color in the HUD image. More than one color/shade can be used for different portions of the 2D cluster 900 at the same time.

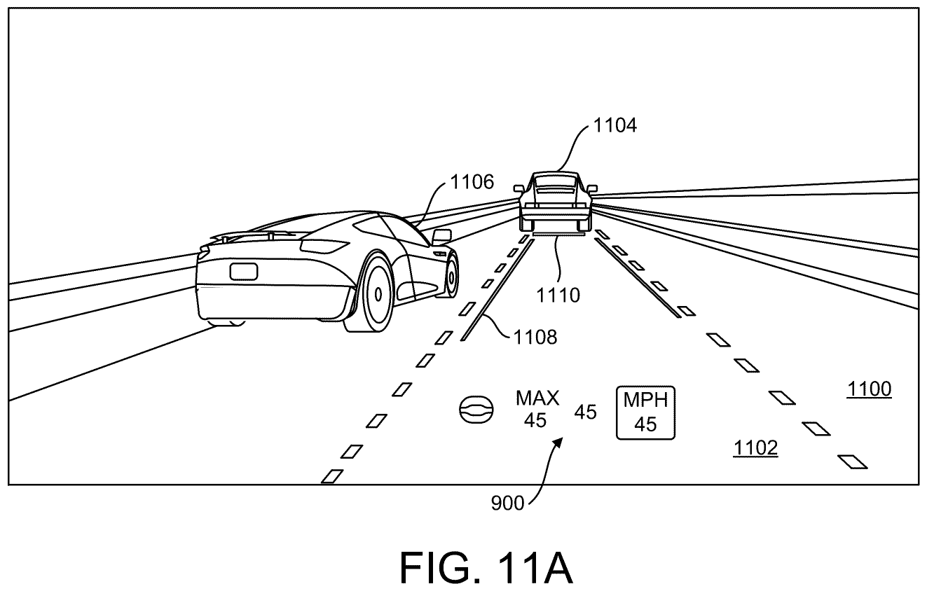

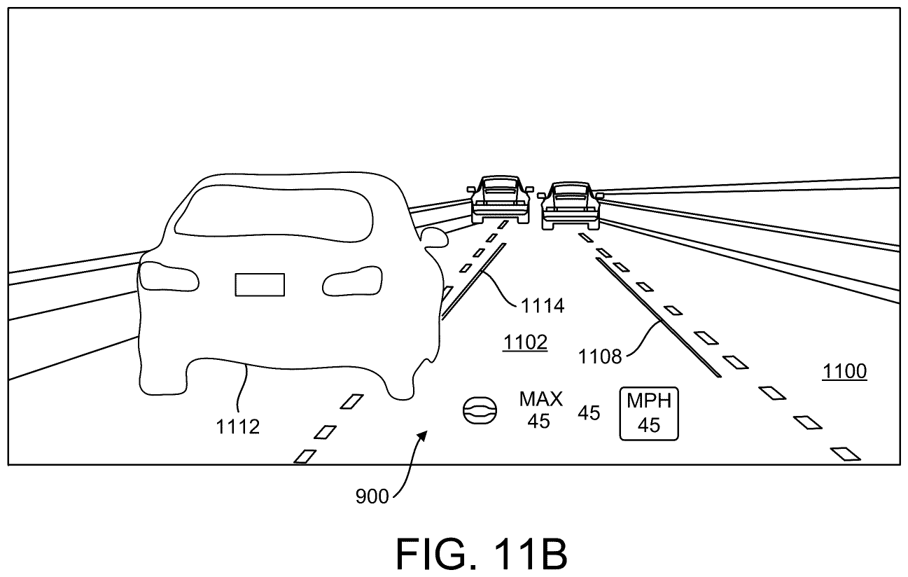

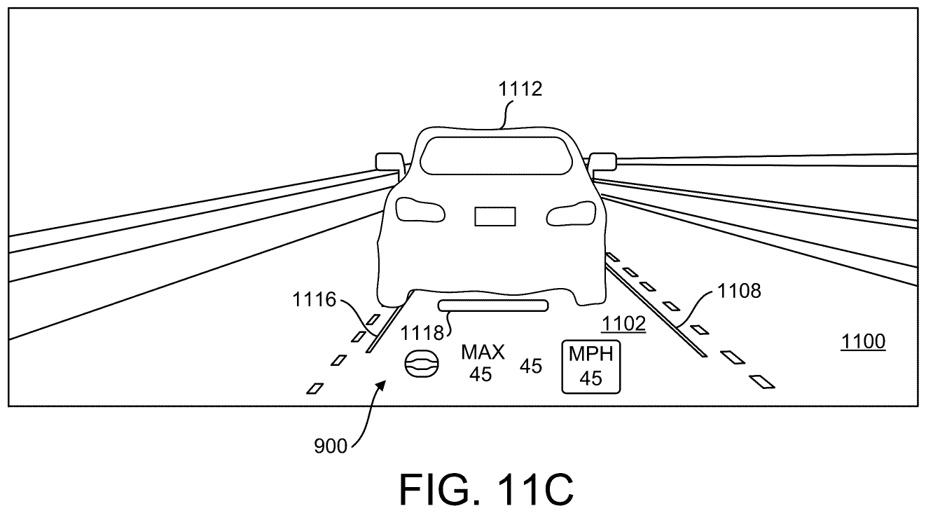

Some examples will now be described with reference to FIGS. 11A-11C that relate to driver assistance using AR content. FIG. 11A shows an example of a HUD image 1100 with the 2D cluster 900 of FIG. 9. The vehicle is here traveling in a lane 1102. Other vehicles are also on the road: a vehicle 1104 is ahead of the vehicle in the lane 1102, and a vehicle 1106 is in an adjacent lane. This can be detected using a perception suite (e.g., a camera, LiDAR and/or radar). One or more longitudinal lines 1108 can be presented in the HUD image 1100. The longitudinal lines 1108 can be presented in a road surface AR plane to aid the driver in maintaining the correct position on the road. For example, the longitudinal lines 1108 can indicate the width of the vehicle. A vehicle marker 1110 can be presented at the vehicle 1104 to indicate that the driver's vehicle is following behind the vehicle 1104 (e.g., the vehicle 1104 can be considered a leading vehicle with regard to the driver's vehicle).

FIG. 11B shows another example of the HUD image 1100 with the 2D cluster 900 of FIG. 9. A vehicle 1112 is merging into the lane 1102 from the left ahead of the driver's vehicle. The one of the longitudinal lines 1108 that is on the right is not implicated by the vehicle 1112 and can remain unchanged from before. However, the one of the longitudinal lines 1108 that is on the left can now be partially occluded so that a longitudinal line 1114 is instead presented. A portion of the longitudinal line 1114 is occluded compared to the longitudinal line 1108 based on the presence of the vehicle 1112. The occlusion can be done dynamically. For example, the longitudinal line 1114 can be increasingly occluded along its length as the vehicle 1112 continues to enter the lane 1102 to ensure that the AR content remains realistic.

FIG. 11C shows another example of the HUD image 1100 with the 2D cluster 900 of FIG. 9. Here, the vehicle 1112 has continued merging into the lane 1102. The one of the longitudinal lines 1108 that is on the left can now be partially occluded so that a longitudinal line 1116 is instead presented. The occlusion can be done dynamically. For example, the longitudinal line 1116 can be decreasingly occluded along its length as the vehicle 1112 continues to enter the lane 1102 to ensure that the AR content remains realistic. The one of the longitudinal lines 1108 that is on the right is not implicated by the vehicle 1112 and can remain unchanged from before. A vehicle marker 1118 can be presented at the vehicle 1112 to indicate that the driver's vehicle is following behind the vehicle 1112 (e.g., the vehicle 1112 can be considered a leading vehicle with regard to the driver's vehicle).

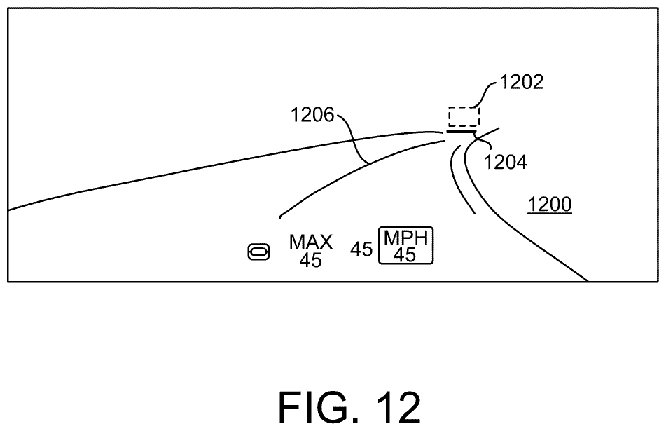

FIG. 12 shows an example of a HUD image 1200 presented during poor visibility. During inclement weather conditions or when lighting is insufficient, the HUD system can provide driver assistance to counteract impaired visibility. In some implementations, high-definition (HD) map data can be fused with a radar detector and/or LiDAR signals, in a perception stack of the vehicle, to give the driver the ability to “see” in impaired conditions. This can involve enabling the driver to perceive upcoming road bends or vehicles ahead. Here, a vehicle 1202 is traveling ahead of the driver's vehicle but may not be visible to the driver due to darkness, fog, snow, etc. The driver's vehicle detects the vehicle 1202 using the sensor(s) and presents a vehicle marker 1204 in the HUD image that indicates the position of the vehicle 1202. The HUD system can, based on vehicle position information and HD map data, also present longitudinal lines 1206 indicating where the road is and whether it bends. Accordingly, the HUD image 1200 can allow the driver to see during impaired visibility.

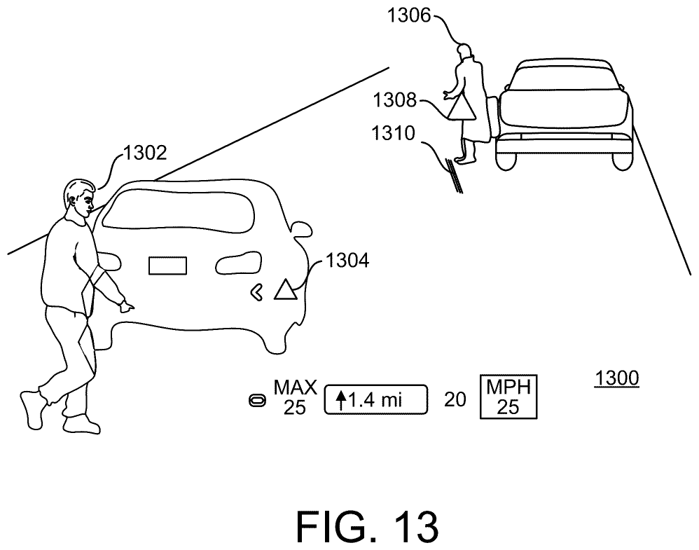

FIG. 13 shows an example of a HUD image 1300 that can warn a driver of lane intrusions. Based on sensor output, the driver's vehicle can update the HUD image 1300 in one or more ways to warn of possible danger. Here, a person 1302 is walking from the left into the path of the driver's vehicle. The HUD system can therefore present a warning 1304. For example, the warning 1304 can include a warning triangle and/or an arrow pointing toward the hazard. Here, a person 1306 is opening a vehicle door on the right side that may encroach on the path of the driver's vehicle. The HUD system can therefore present a warning 1308 and/or a longitudinal line 1310. For example, the warning 1308 and/or the longitudinal line 1310 can be presented in response to detecting that the person 1302 is positioned across a longitudinal line that indicates the width of the driver's vehicle. Presenting the longitudinal line 1310 can involve changing a color (e.g., from a neutral color to red) of an already presented longitudinal line in the HUD image 1300. The warnings 1304 and 1308 can be presented in a vertical AR plane, and the longitudinal line 1310 in a road surface AR plane, of the HUD image 1300.

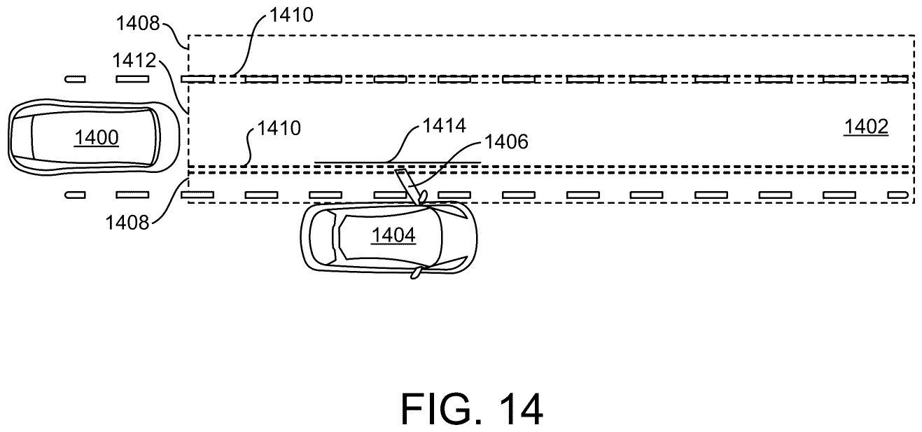

FIG. 14 schematically shows an example of a vehicle 1400 and active object detection. The vehicle 1400 is shown from above while positioned on a road 1402 where a vehicle 1404 is also present. A door 1406 of the vehicle 1404 is open and encroaches on the path traveled by the vehicle 1400. The driver assistance system of the vehicle 1400 can define one or more regions 1408 that are safe (e.g., where objects present in the regions 1408 do not interfere with the travel of the vehicle 1400). The driver assistance system of the vehicle 1400 can define one or more regions 1410 that are cautionary (e.g., where objects present in the regions 1410 may interfere with the travel of the vehicle 1400). The driver assistance system of the vehicle 1400 can define one or more regions 1412 that are critical (e.g., where objects present in the regions 1412 do interfere with the travel of the vehicle 1400). The region 1412 can correspond to a minimum width for the vehicle 1400. One or more alerts can be generated based on sensor detections with regard to the regions 1408-1412. For example, a longitudinal line 1414 is here presented in the region 1412 to highlight that the door 1406 of the vehicle 1404 is present within the region 1412.

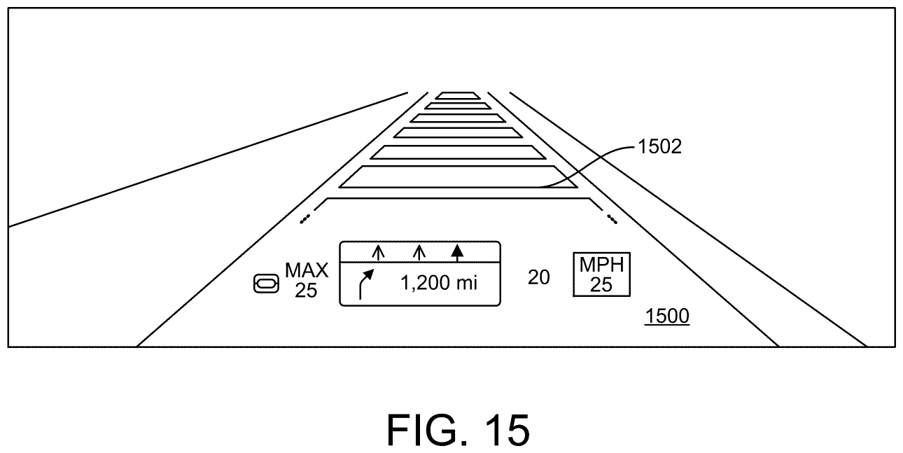

FIG. 15 shows an example of a HUD image 1500 with AR content that can warn about speed ahead of an upcoming road turn. The vehicle is currently traveling on a road for which the assisted driving system has access to standard definition (SD) or HD map data. The system also has access to the vehicle's current location, e.g., based on GPS. The system can therefore determine that a road turn is upcoming. A maximum turn speed can be defined for the road turn (e.g., based on the curvature radius). Based on vehicle dynamics, the system can determine whether the vehicle is exceeding the maximum turn speed for the upcoming road turn. If so, a warning can be generated. In some implementations, AR distance markers 1502 are presented as the vehicle approaches the turn, and the AR distance markers 1502 can be highlighted in color (e.g., progressively redder).

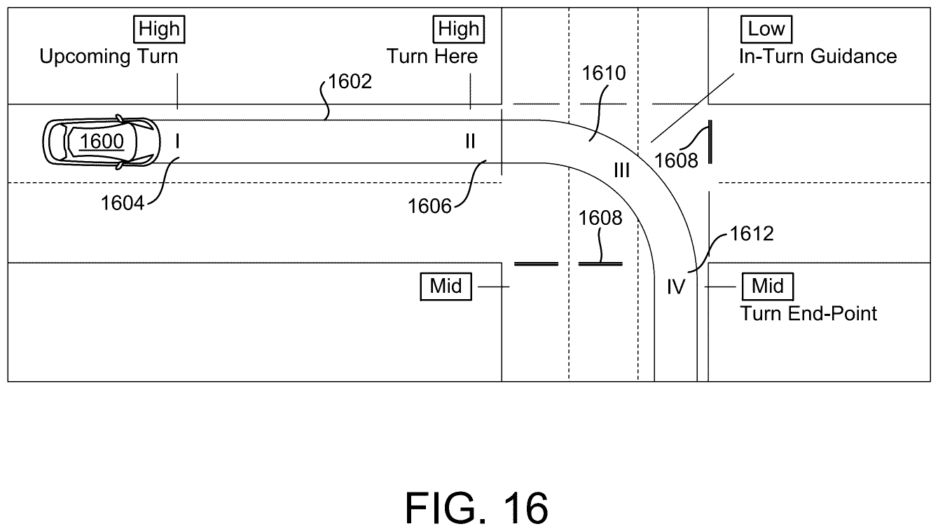

FIG. 16 shows an example of turn guidance stages. A vehicle 1600 is shown from above while traveling toward a four-way intersection. A planned path 1602 for the vehicle 1600 in making the instructed turn is here indicated as a band extending along the road. The driver assistance system has divided the turn into discrete sections (here labeled I, II, III and IV, respectively), which can guide the HUD assistance provided to the driver. A section 1604 corresponds to an “upcoming turn” status. This can be a stage of relatively high value for the driver. For example, a turn symbol (not shown) can be presented as AR content in a HUD image to guide the driver. A section 1606 corresponds to a “turn here” status. This can be a stage of relatively high value for the driver. To guide the driver in the section 1606, AR content 1608 can be presented in the HUD image (e.g., using a red color) to indicate that the vehicle 1600 should not continue straight through the intersection, and also that the vehicle 1600 should not turn into the rightmost lanes of the crossing road. A section 1610 corresponds to an “in-turn guidance” status. This can be a stage of relatively low value for the driver. For example, the turning can be guided using a turn symbol or a target symbol. A section 1612 corresponds to a “turn endpoint” status. This can be a stage of medium value for the driver. For example, the turn endpoint can be guided by merging a target symbol with a completed countdown indicator.

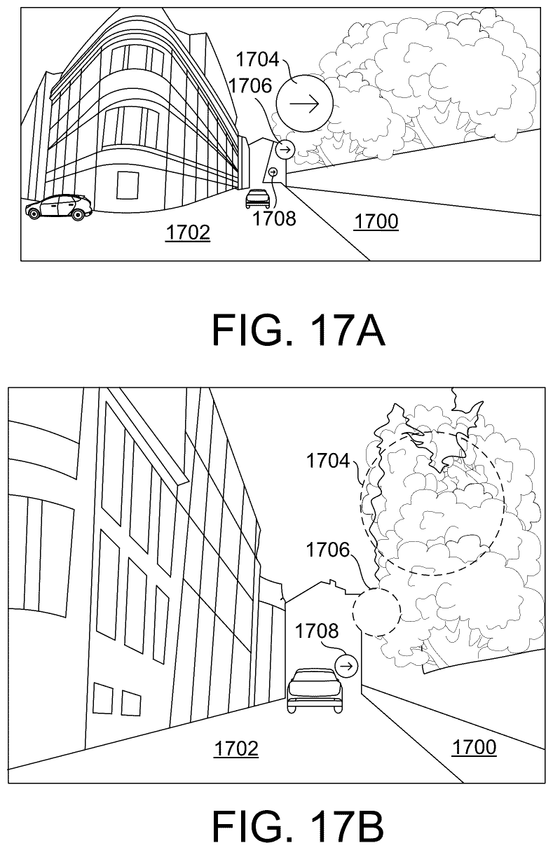

FIG. 17A shows an example of a HUD image 1700 with AR content. Here a vehicle is traveling along a road 1702 according to a defined navigation route. Here, navigation symbols 1704, 1706 and 1708 are concurrently presented (e.g., in respective vertical AR planes) with regard to the road 1702. For example, each of the navigation symbols 1704, 1706 and 1708 corresponds to a turn that the vehicle is supposed to make. The navigation symbols 1704, 1706 and 1708 are associated with different distances from a current location of the vehicle. For example, the navigation symbol 1704 is the nearest, the navigation symbol 1708 is the farthest, and the navigation symbol 1706 is the intermediate. However, a driver can struggle with understanding where, relative to the real world, AR contents are positioned and therefore have difficulty determining when action is needed. That is, while the navigation symbol 1704 is larger than the other navigation symbols, the depth position may not be immediately clear to the driver. Artificial depth can therefore be applied, as will now be described.

FIG. 17B shows an example of the HUD image 1700 where some of the AR content is blurred. The AR content (e.g., one or more navigation symbols) closest to the vehicle can be blurred. Here, the navigation symbol 1704 and the navigation symbol 1706 are being blurred, as schematically indicated by a broken outline. The navigation symbol 1708, by contrast, is currently not being blurred. The artificial depth can blur one or more elements to force a sense of depth and thereby enhance a sense of timing and distance with AR elements. The blur strength can be inversely proportional to the distance from the vehicle.

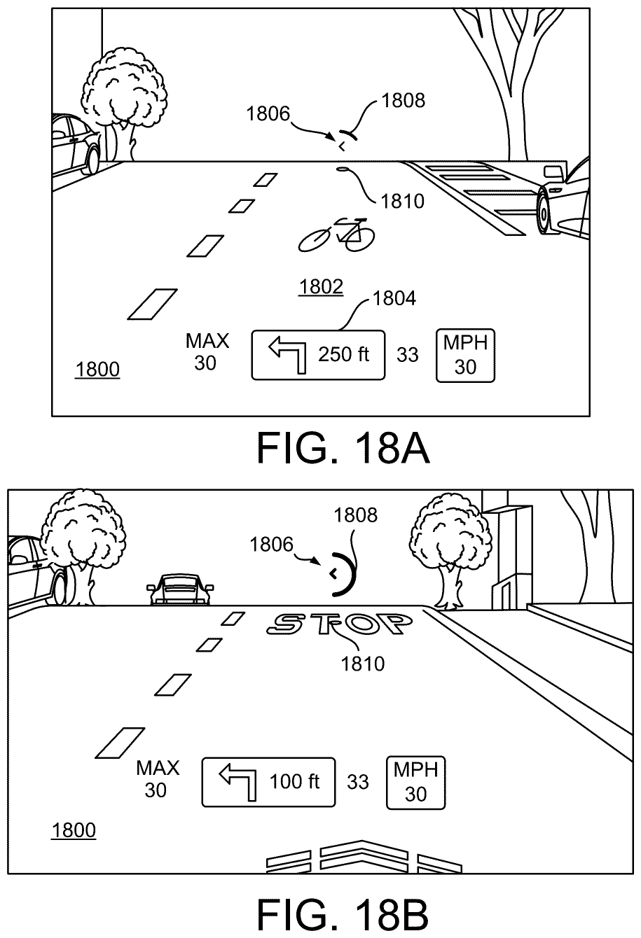

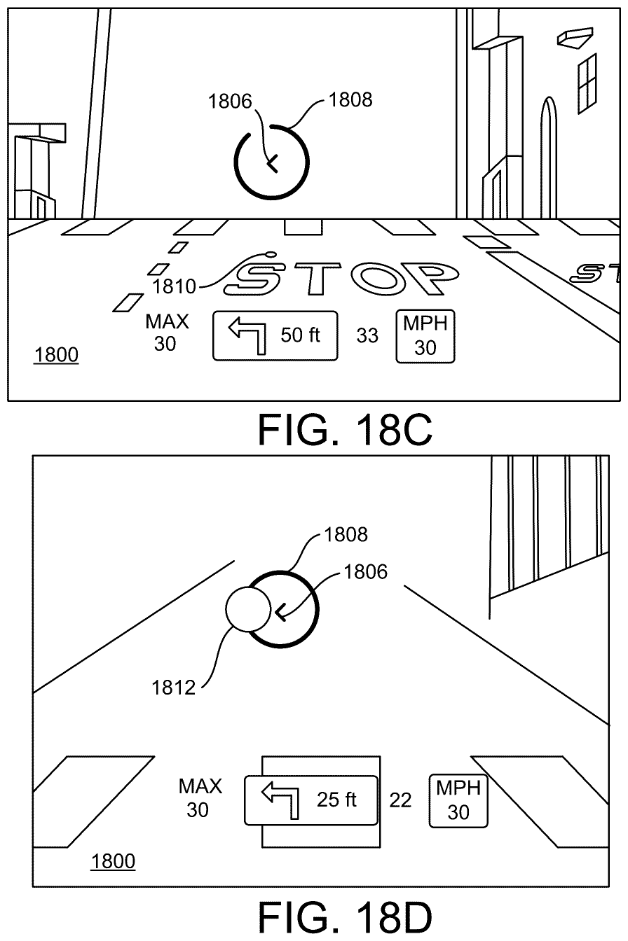

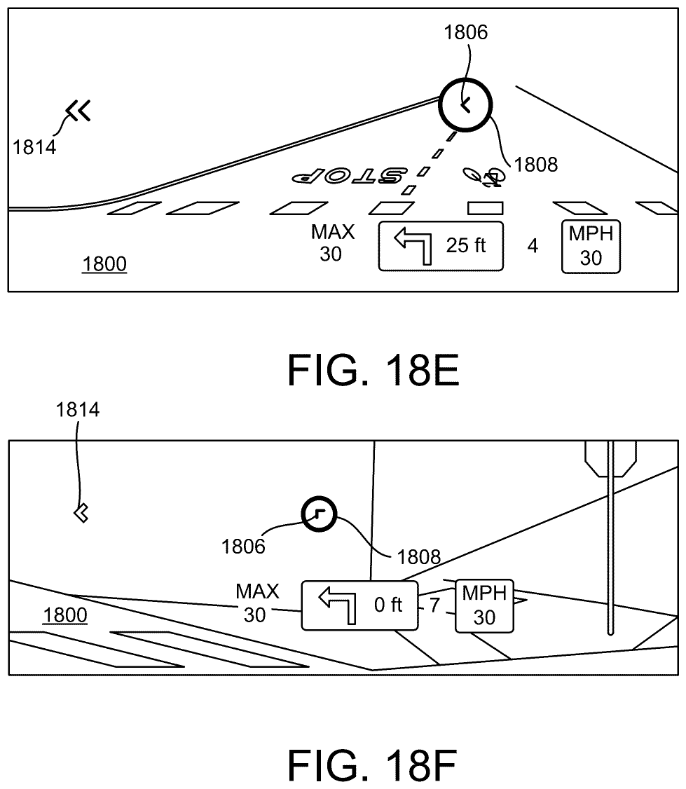

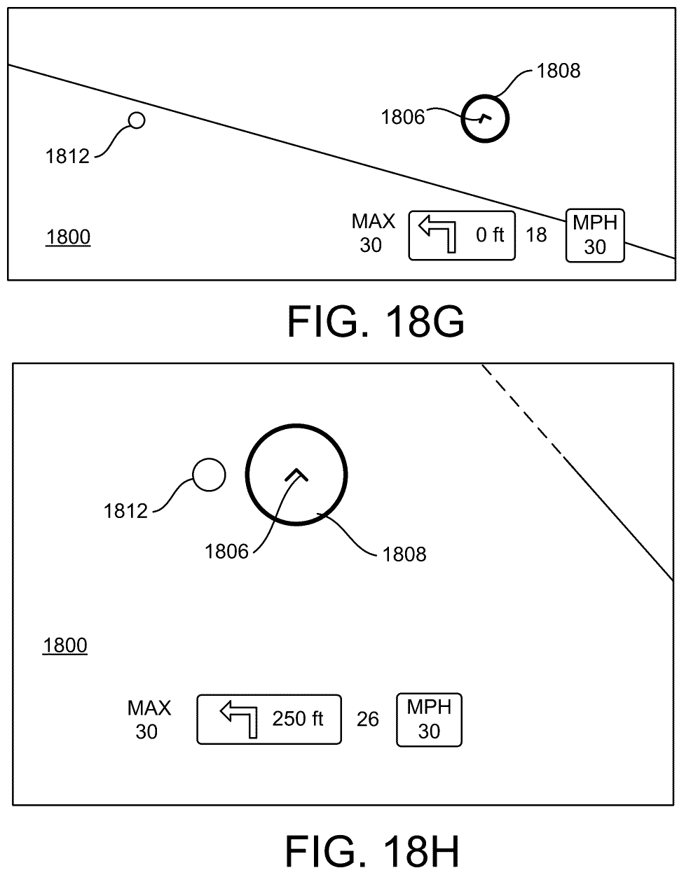

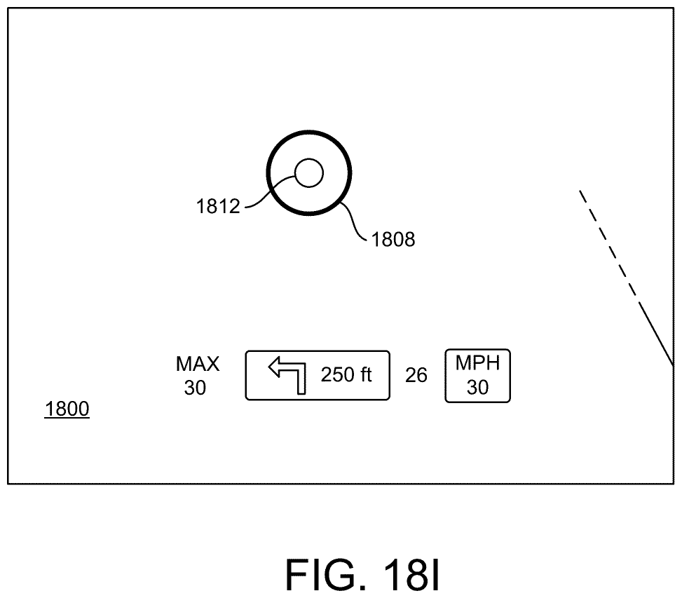

Examples of supporting navigation using AR content in a HUD image will now be described with reference to FIGS. 18A-18I. In these examples, the physical environment surrounding the vehicle is schematically illustrated or omitted for simplicity. FIG. 18A shows an example of a HUD image 1800 with AR content for navigation. The vehicle is traveling on a road 1802 and a navigation system of the vehicle has defined navigation instructions for driving toward a target destination (not shown). Next, the navigation instructions urge the driver of the vehicle to make a left turn at a particular location. An element 1804 in a 2D cluster of the HUD image 1800 indicates that the vehicle is currently 250 feet away from that location. The HUD system can include a turn symbol 1806 (e.g., an arrow) in the AR content. The turn symbol 1806 corresponds to the turn that the driver is supposed to make. For example, the turn symbol 1806 can include a caret pointing in the direction of the turn. The HUD system can include a countdown indicator 1808 in the AR content. The countdown indicator 1808 indicates a remaining time until the vehicle reaches the location. The turn symbol 1806 and the countdown indicator 1808 can be presented in a vertical AR plane of the HUD image 1800. The HUD system can include a grounding element 1810 in the AR content. The grounding element 1810 can correspond to the turn symbol 1806 and the countdown indicator 1808 and can give the driver a sense of where in the real world these AR elements are located. The grounding element 1810 can be positioned in the road surface AR plane of the HUD image 1800.

FIG. 18B shows another example of the HUD image 1800 with the AR content. This example shows that the vehicle has proceeded closer to the turn location (here, intersection). The turn symbol 1806, the countdown indicator 1808 and the grounding element 1810 are visible. The countdown indicator 1808 has progressed to indicate that less time remains until the vehicle reaches the location. In addition to the progression of the countdown indicator 1808, each of the turn symbol 1806, the countdown indicator 1808 and the grounding element 1810 is also presented in a larger size than in FIG. 18A.

FIG. 18C shows another example of the HUD image 1800 with the AR content. This example shows that the vehicle is almost at the turn location (here, intersection). The turn symbol 1806, the countdown indicator 1808 and the grounding element 1810 are visible. The countdown indicator 1808 has progressed to indicate that very little time remains until the vehicle reaches the location. In addition to the progression of the countdown indicator 1808, each of the turn symbol 1806, the countdown indicator 1808 and the grounding element 1810 is also presented in a larger size than in FIGS. 18A-18B.

FIG. 18D shows another example of the HUD image 1800 with the AR content. This example shows that the vehicle is at the turn location (here, intersection). The turn symbol 1806 and the countdown indicator 1808 are visible. The countdown indicator 1808 has progressed to completion (e.g., a full clockwise circle) to indicate that the vehicle has reached the location. In addition to the progression of the countdown indicator 1808, the turn symbol 1806 and the countdown indicator 1808 are also presented in a larger size than in FIGS. 18A-18C.

The AR content here also includes a target symbol 1812. For example, the target symbol 1812 can include a target dot (e.g., a circular AR element). The target symbol 1812 can initially appear inside the countdown indicator 1808 (e.g., inside a circular progress bar). The target symbol 1812 can move horizontally (e.g., move in a horizontal direction within the HUD image 1800) as the vehicle begins performing the turn according to the navigation instruction. On the other hand, the turn symbol 1806 and the countdown indicator 1808 can remain stationary in the HUD image 1800 (e.g., remain stationary on the windshield of the vehicle) during the turn. The grounding element 1810 may be omitted from the AR content in response to the vehicle reaching the location of the turn.

FIG. 18E shows another example of the HUD image 1800 with the AR content. This example shows that the vehicle has begun performing the turn at the location (here, intersection). The turn symbol 1806 and the countdown indicator 1808 are visible. The target symbol 1812 of FIG. 18D has moved horizontally out of the HUD image 1800 (here, in a direction toward the left) and is no longer visible in the HUD image 1800. Instead, the AR content includes a target offscreen indicator 1814. The target offscreen indicator 1814 indicates that the target to which the target symbol 1812 corresponds is outside the HUD image 1800. The target offscreen indicator 1814 can include one or more arrows pointing toward the target.

FIG. 18F shows another example of the HUD image 1800 with the AR content. This example shows that the vehicle continues to perform the turn at the location (here, intersection). The turn symbol 1806, the countdown indicator 1808 and the target offscreen indicator 1814 are visible. As in FIG. 18E, the target symbol 1812 of FIG. 18D is not visible in the HUD image 1800 because the target is not located within the HUD image 1800, and the target offscreen indicator 1814 points toward the target. The turn symbol 1806 has been rotated compared to the previous illustrations to better align with the direction that the vehicle should be traveling at this moment according to the defined turn of the navigation. That is, the turn symbol 1806 was previously pointing west in the HUD image 1800 and is now pointing approximately in a northwest direction.

FIG. 18G shows another example of the HUD image 1800 with the AR content. This example shows that the vehicle further continues to perform the turn at the location (here, intersection). The turn symbol 1806 and the countdown indicator 1808 are visible. Also, the target of the navigation turn has again entered inside the HUD image 1800, so the target symbol 1812 is again included in the AR content. The target offscreen indicator 1814 of FIGS. 18E-18F is therefore no longer included in the AR content. The turn symbol 1806 has continued to be rotated to better align with the direction that the vehicle should be traveling at this moment according to the defined turn of the navigation. That is, the turn symbol 1806 is now pointing approximately in a north-northwest direction.

FIG. 18H shows another example of the HUD image 1800 with the AR content. This example shows that the vehicle has almost completed the turn at the location (here, intersection). The turn symbol 1806, the countdown indicator 1808 and the target symbol 1812 are visible. The target symbol 1812 has moved horizontally toward the turn symbol 1806 and the countdown indicator 1808 as the turning proceeds. The turn symbol 1806 has continued to be rotated to better align with the direction that the vehicle should be traveling at this moment according to the defined turn of the navigation. That is, the turn symbol 1806 is now pointing approximately north, which corresponds to driving essentially straight forward. As such, at an end of the turn, the turn symbol 1806 can be oriented vertically upward on the windshield.

FIG. 18I shows another example of the HUD image 1800 with the AR content. This example shows that the vehicle has completed the turn at the location (here, intersection). The countdown indicator 1808 and the target symbol 1812 are visible. As the turning proceeded, the target symbol 1812 moved horizontally toward, and entered inside, the countdown indicator 1808. There, the target symbol 1812 merged with the turn symbol 1806 of FIGS. 18A-18H, which is no longer visible in the HUD image 1800. That is, the target symbol 1812 being centered inside the countdown indicator 1808 indicates to the driver that the vehicle has completed the defined navigation turn and that the vehicle is currently traveling in the correct direction according to the navigation.

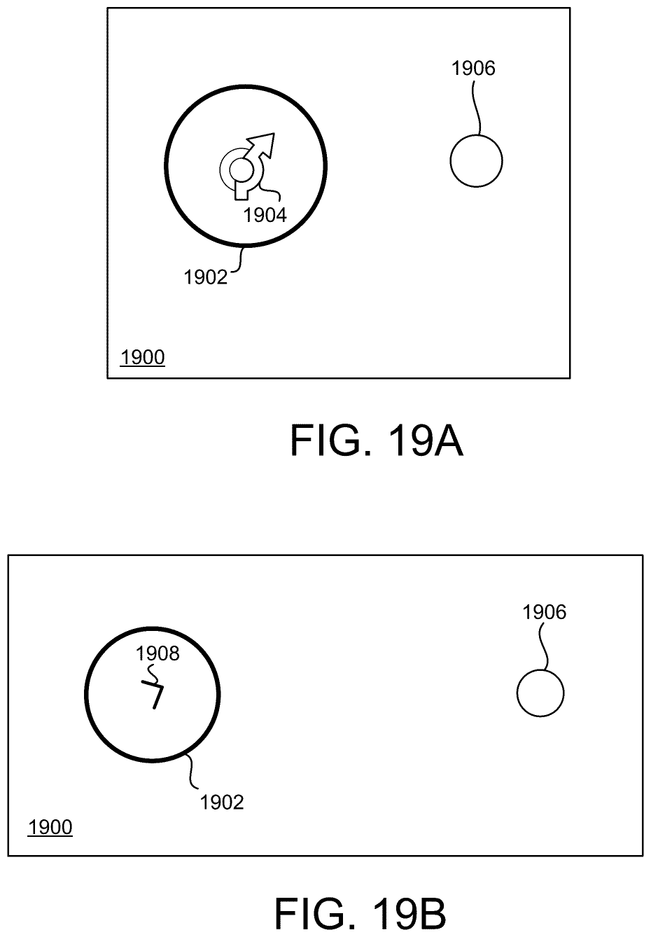

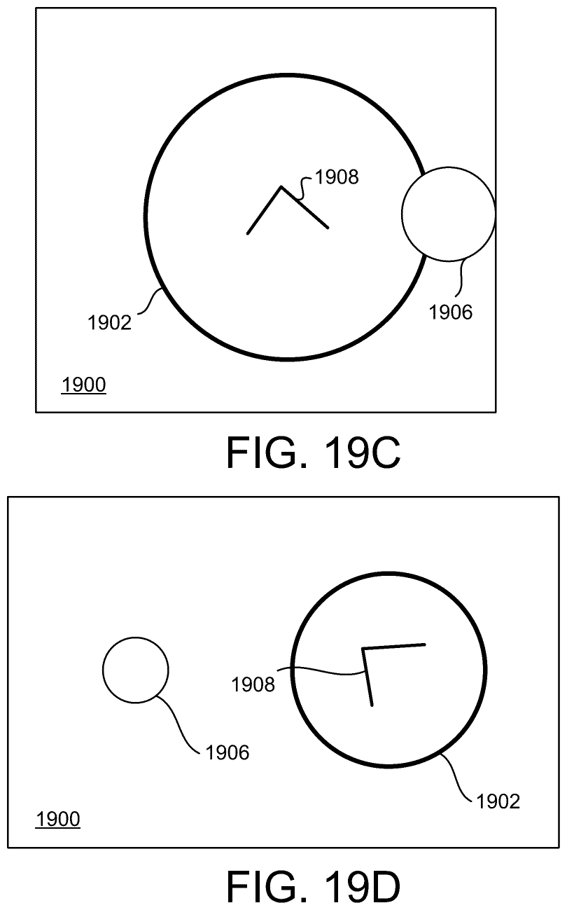

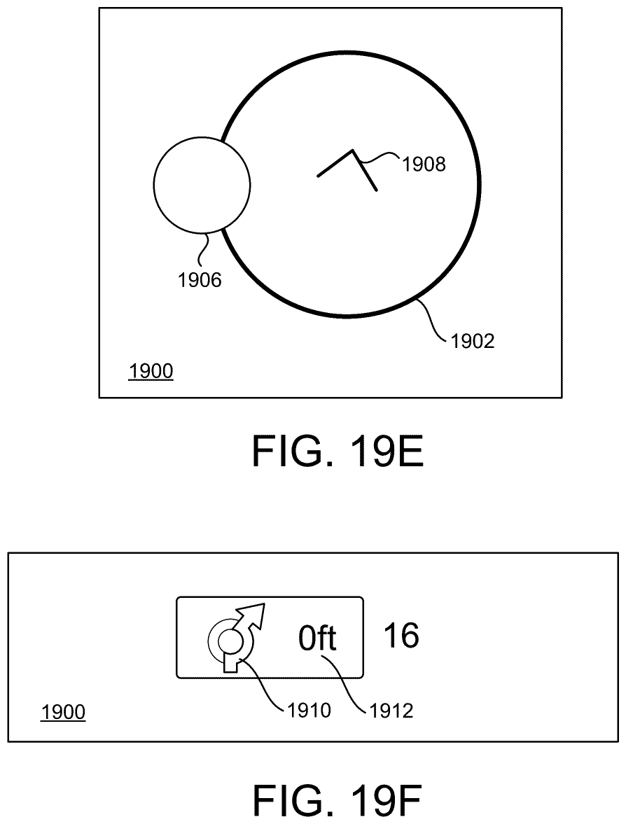

Against the background of the examples described with reference to FIGS. 18A-18I, which involved a situation of turning left in a road intersection, additional examples involving a roundabout will now be described with reference to FIGS. 19A-19F. A roundabout is a circular intersection or junction where a vehicle can exit using any of multiple exits. Generally, in regions that use right-hand traffic, the roundabouts circulate counterclockwise, and vice versa for regions that use left-hand traffic. In the following examples, the physical environment surrounding the vehicle is omitted for simplicity.

FIG. 19A shows an example of a HUD image 1900 with AR content for navigation. The HUD image 1900 can be presented, by a HUD system, on a vehicle windshield to guide a driver in proceeding through a roundabout as part of navigation to a destination. Leading up to the vehicle's arrival at the roundabout, a countdown indicator 1902 can be presented, which can continuously indicate a remaining time until the vehicle reaches the roundabout, in analogy with the examples above (e.g., the countdown indicator 1902 can include a circular progress bar proceeding in a clockwise direction). Here, the vehicle has already reached the roundabout, and the countdown indicator 1902 has completed its countdown. The AR content of the HUD image 1900 also includes a turn symbol 1904 that corresponds to the turn that the vehicle is expected to make through the roundabout, and a target symbol 1906. For example, the turn symbol 1904 here includes a shape that corresponds to an exit from a roundabout. The target symbol 1906 can move horizontally on the windshield to indicate a target of the turn. The turn symbol 1904 can include an arrow.

FIG. 19B shows another example of the HUD image with the AR content. This example shows that the vehicle has entered the roundabout and is traveling toward the specific exit of the multiple exits thereof that has been selected by the navigation system for the present navigation. The turn symbol 1904 of FIG. 19A is therefore no longer included in the AR content. Instead, the AR content includes a turn symbol 1908 inside the countdown indicator 1902. The turn symbol 1908 can include an arrow pointing in the direction of the turn that the driver is currently expected to make. Here, the roundabout uses right-hand traffic, and the turn symbol 1908 is therefore oriented toward the right. The target symbol 1906 has moved horizontally to the right to indicate where the target is located.

FIG. 19C shows another example of the HUD image 1900 with the AR content. This example shows that the vehicle continues to travel toward the designated exit. The countdown indicator 1902, the target symbol 1906 and the turn symbol 1908 are visible. The turn symbol 1908 has been rotated to better align with the direction that the vehicle should be traveling at this moment according to the defined turn of the navigation.

FIG. 19D shows another example of the HUD image 1900 with the AR content. This example shows that the vehicle continues to travel toward the designated exit. The countdown indicator 1902, the target symbol 1906 and the turn symbol 1908 are visible.

FIG. 19E shows another example of the HUD image 1900 with the AR content. This example shows that the vehicle has entered the designated exit. The countdown indicator 1902, the target symbol 1906 and the turn symbol 1908 are visible. As the vehicle completes the turn specified by the navigation system, the target symbol 1906 can merge with at least one of the countdown indicator 1902 or the turn symbol 1908. This can indicate to the driver that the turn has been correctly performed and that the vehicle is on the right way.

The HUD image 1900 can include a 2D cluster during some or all of the navigation in the above example. FIG. 19F shows another example of the HUD image 1900 with the AR content. Here, a 2D cluster includes a turn symbol 1910 indicating that the current turn takes place in a roundabout (e.g., similar to the turn symbol 1904 that was presented in the vertical AR plane as shown in FIG. 19A). The 2D cluster can also include a distance measurement 1912 indicating that the distance to the location of the turn is currently zero feet.

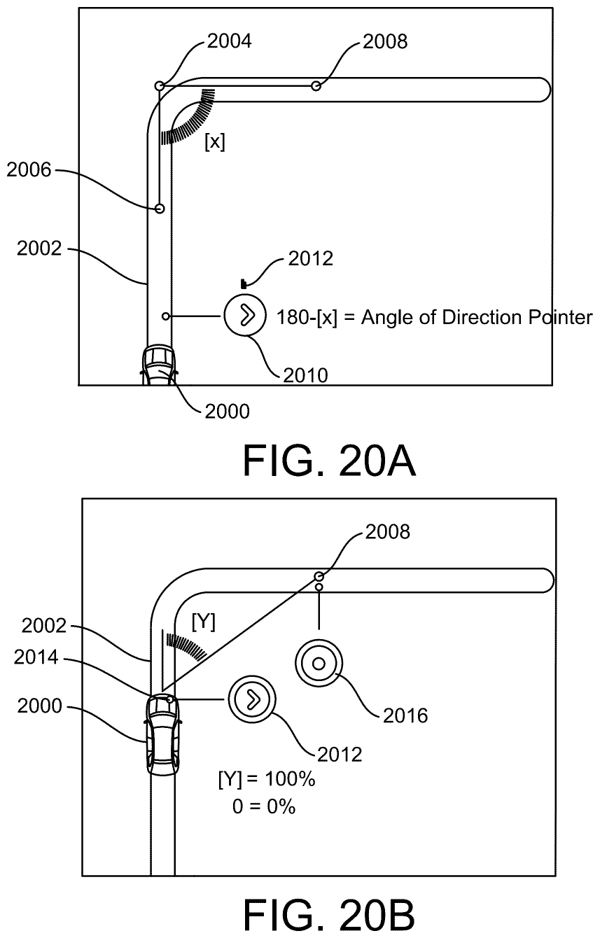

FIG. 20A schematically shows an example relating to a turn symbol and a target symbol that can be presented as AR content in a HUD image. FIG. 20B shows another example relating to the turn symbol and the target symbol of FIG. 20A. These examples involve a vehicle 2000 slated to travel, according to navigation instructions, along a path 2002 that makes a turn to the right (in this situation). To correctly determine the sharpness of the turn maneuver the driver assistance system can calculate the angle using start and end offsets from a turn point. A turn point 2004 can be defined for the path 2002. The turn point 2004 can be considered a GPS turn point and can be defined for purposes of planning the vehicle's travel during the turn, although the vehicle may not actually traverse the turn point 2004 while making the turn. A start offset point 2006 can be defined on the path 2002 some distance before the turn point 2004. An end offset point 2008 can be defined on the path 2002 some distance after the turn point 2004. The length of the start offset point 2006 and/or the end offset point 2008 can be specified based on the type of road where the vehicle 2000 is traveling. Together, the start offset point 2006, the turn point 2004 and the end offset point 2008 can define an angle [x] for the turn. Such a calculation can be performed to facilitate giving the driver a clear understanding of what maneuver they can expect. A turn symbol 2010 corresponding to the turn can be presented as AR content in a HUD image to guide the driver in making the turn. The turn symbol 2010 can be rotated based on [x]. In some implementations, the angle of the turn symbol 2010 can be defined as 180−[x]. For example, that definition here results in the turn symbol 2010 being oriented toward the right. Other approaches can be used. A countdown indicator 2012 (which has here counted down only a minor amount) can at least partially surround the turn symbol 2010.

Once the vehicle 2000 reaches the start offset point 2006 the calculated angle can shift to be directly proportional to vehicle rotation. This enables the HUD system to provide live feedback based on the position of the target of the navigation instruction for the turn. As the vehicle 2000 approaches the turn, a vehicle location 2014 can be defined at various points (e.g., in a substantially continuous fashion). Based on the vehicle location 2014, the path 2002 and the end offset point 2008, an angle [Y] can be defined. As the angle [Y] reduces (e.g., when turning in the correct direction) the turn symbol 2010 can rotate accordingly so as to stay on target. When the vehicle completes the turn, a symbol 2016 can be included in the AR content of the HUD image. For example, the symbol 2016 indicates that the vehicle has completed the turn.

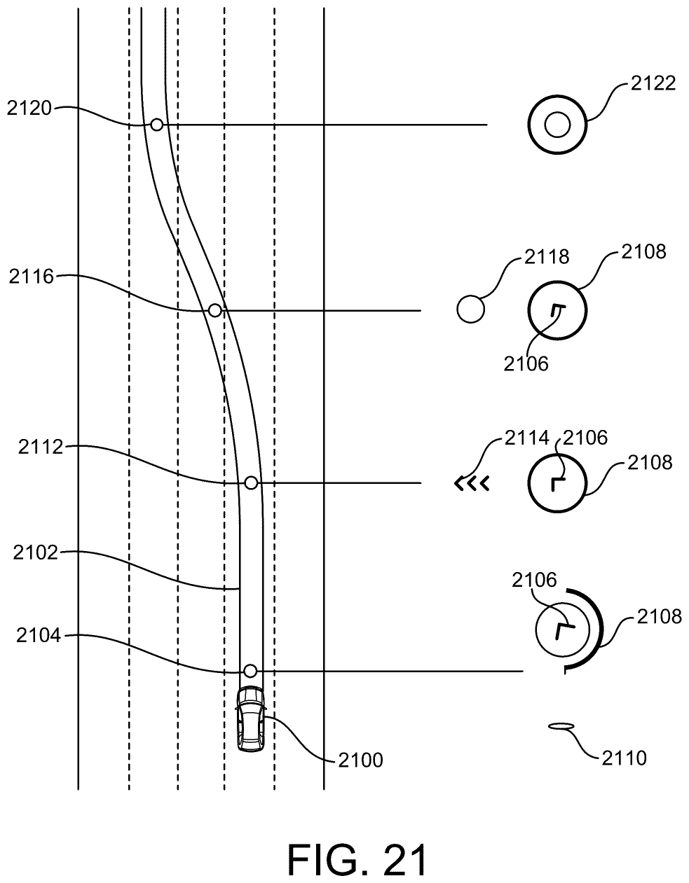

FIG. 21 schematically shows an example relating to AR content that can be presented in a HUD image. These examples involve a vehicle 2100 slated to travel, according to navigation instructions, along a path 2102 that makes a turn to the left (in this situation). For example, traversing the path 2002 can involve lane guidance while making a lane change. This can require the vehicle 2100 to know where it is in order to know what maneuver is needed for where the vehicle 2100 needs to be next. To facilitate this, a merger of driver assistance data and navigation data can be performed. For example, the driver assistance navigation can detect the current lane of the vehicle 2100, and the navigation system can know in which lane the vehicle 2100 needs to be.

At a location 2104 along the path 2102, AR content can be presented in the HUD image, the AR content including a turn symbol 2106, a countdown indicator 2108, and a grounding element 2110 for the turn symbol 2106 and the countdown indicator 2108. At a location 2112, the vehicle 2100 has begun performing the turn, and the AR content can then include the turn symbol 2106, the countdown indicator 2108 and a target offscreen indicator 2114. At a location 2116, the vehicle 2100 is in the process of performing the turn, and the AR content can then include the turn symbol 2106, the countdown indicator 2108, and a target symbol 2118 that can move horizontally. At a location 2120, the vehicle 2100 has completed the turn according to the navigation instruction, and the AR content can then include a symbol 2122 corresponding to a merger of the target symbol 2118 with the countdown indicator 2108.

The above and other examples illustrate that a method can include: generating, by a navigation system of a vehicle (e.g., any of the vehicles above), at least one navigation instruction to instruct a driver of the vehicle to make a turn (e.g., any of the turns above) at a location; presenting, using a HUD system of the vehicle, a HUD image (e.g., any of the HUD images above) on a windshield of the vehicle, the HUD image comprising AR content (e.g., any of the AR contents above) including i) a turn symbol corresponding to the turn (e.g., any of the turn symbols above), and ii) a countdown indicator at least partially surrounding the turn symbol (e.g., any of the countdown indicators above); updating the HUD image, before the vehicle reaches the location, so that the countdown indicator indicates a remaining time until the vehicle reaches the location; and updating the HUD image, after the vehicle reaches the location, so that the turn symbol rotates to indicate a direction of the turn.

The above and other examples also illustrate that a method can include: generating, by a navigation system of a vehicle (e.g., any of the vehicles above), at least one navigation instruction to instruct a driver of the vehicle to make a turn (e.g., any of the turns above) at a location; presenting, using a HUD system of the vehicle, a HUD image (e.g., any of the HUD images above) on a windshield of the vehicle, the HUD image comprising AR content (e.g., any of the AR contents above) including a turn symbol corresponding to the turn (e.g., any of the turn symbols above); and updating the HUD image, after the vehicle reaches the location, to also include a target symbol (e.g., any of the target symbols above), wherein the turn symbol remains stationary on the windshield, and wherein the target symbol moves in a substantially horizontal direction on the windshield to indicate a target of the turn.

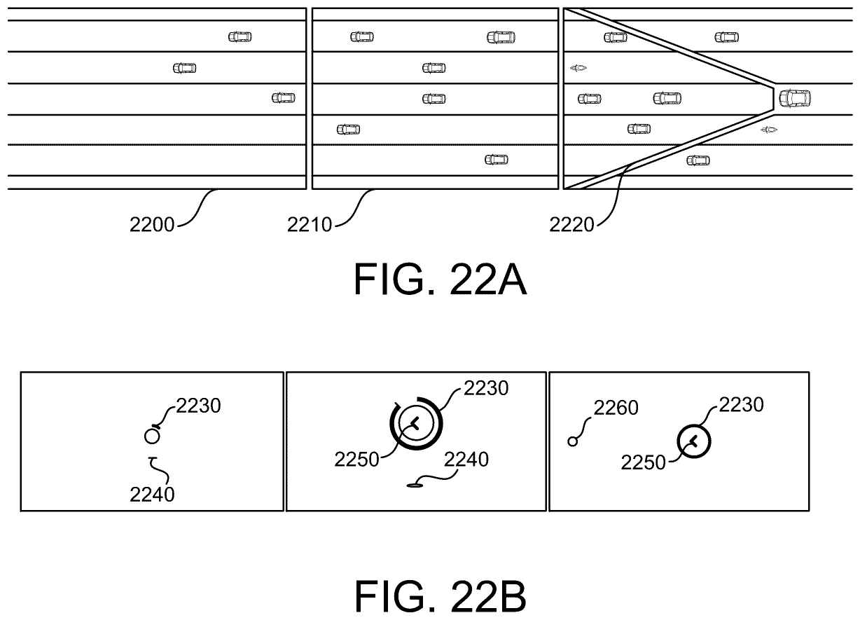

FIG. 22A schematically shows an example of content zones. A content zones framework can be defined to avoid overwhelming the driver with information. In some implementations, information fidelity can be tied to the distance from the vehicle. For example, the closer an AR element is to the vehicle's present location, the more detail the AR element can communicate. An awareness content zone 2200 corresponds to any situation where the driver assistance system of a vehicle informs the driver that, e.g., the vehicle has an upcoming turn planned as part of a navigation. An anticipation content zone 2210 corresponds to any situation where the driver assistance system of a vehicle informs the driver that, e.g., the vehicle has an upcoming turn toward the right. A focus content zone 2220 corresponds to any situation where the driver assistance system of a vehicle informs the driver that, e.g., the vehicle has an upcoming relatively turn toward the right in a short distance (e.g., about 5 meters).

FIG. 22B shows examples of AR content that can be presented at the respective content zones of FIG. 22A. At the awareness content zone 2200 the AR content can include a countdown indicator 2230 and a grounding element 2240. At the anticipation content zone 2210 the AR content can include the countdown indicator 2230, the grounding element 2240 and a turn symbol 2250. At the focus content zone 2220 the AR content can include the countdown indicator 2230, the turn symbol 2250 and a target symbol 2260. As such, progressively more details can be included in the AR content as the vehicle approaches the location. For example, the turn symbol 2250 can be added. As another example, the target symbol 2260 can be added. The AR content can be made larger in the HUD image. For example, the countdown indicator 2230 and the grounding element 2240 are larger in the anticipation content zone 2210 than in the awareness content zone 2200.

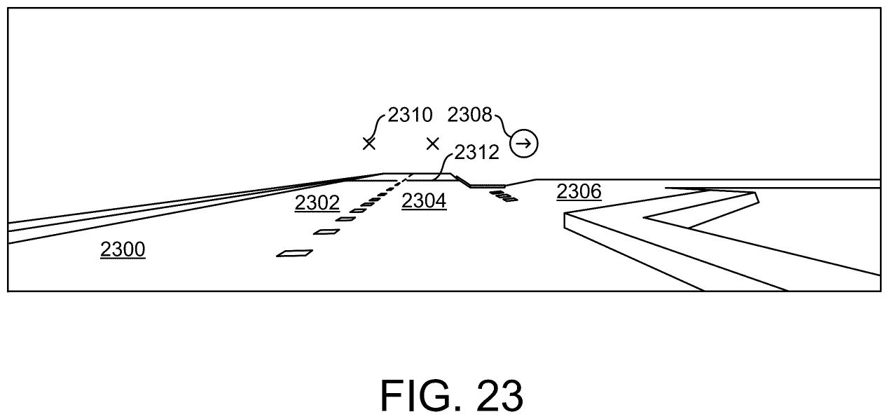

FIG. 23 shows an example of a HUD image 2300 with AR content relating to navigation. The HUD image 2300 is being presented while the vehicle is traveling on a road that includes lanes 2302 and 2304, and an exit ramp 2306. Here, the navigation specifies that the vehicle should take the exit ramp 2306, and a turn symbol 2308 is presented. To assist the driver, one or more symbols 2310 or 2312 can be presented to avoid that the driver proceeds along either of the lanes 2302-2304. For example, the symbols 2310-2312 can have a red color. This can give the driver confidence in navigating routes by highlighting where not to steer the vehicle. For example, this AR content can be used when the navigation issues instructions for driving toward a specified destination, and/or when traffic is heavy and the system proposes the ideal route for proceeding.

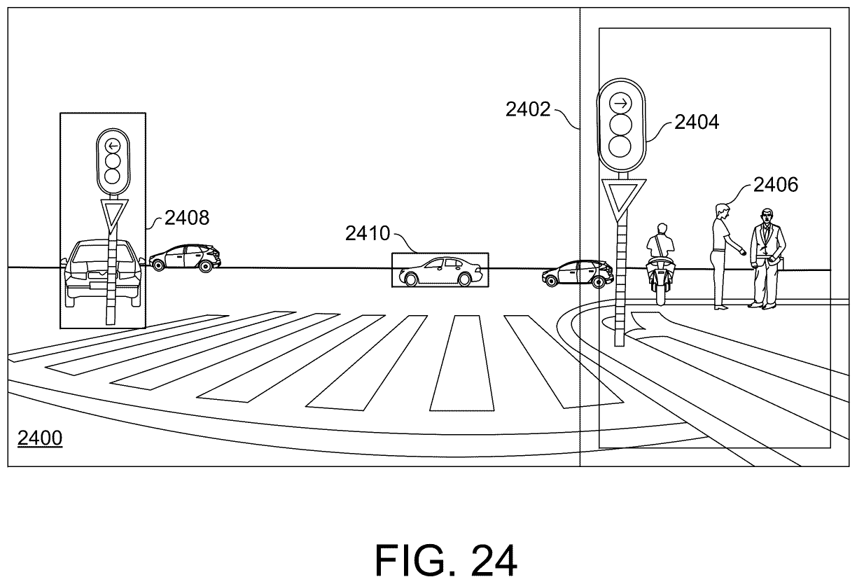

One possible risk with a HUD image is that AR content is presented on top of critical real-world information. This can include traffic signs, traffic lights, pedestrians, vehicles, etc. Critical zones can be defined to leverage dynamic occlusion of AR content so that AR content at risk of obstructing such features is obscured. FIG. 24 shows an example of a HUD image 2400 for which critical zones have been defined. Safety critical zones can be detected using one or more sensors of a perception suite of a driver assistance system. The data can then be processed by the HUD system to ensure conflicts are resolved. Here, a critical zone 2402 is defined based on the presence of at least one traffic light 2404 and/or at least one pedestrian 2406. Critical zones 2408 or 2410 can be defined based on the presence of at least one vehicle and/or a traffic light. Within a critical zone, the occlusion can be performed so that the AR content at issue appears to be “behind” the critical feature (e.g., traffic light, pedestrian or vehicle) from the driver's perspective. As such, the AR content does not obscure the critical feature.

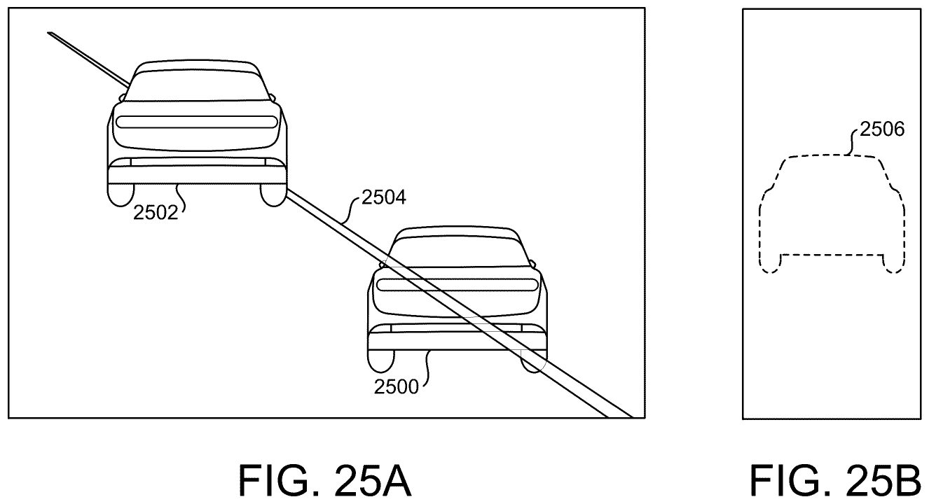

Dynamic occlusion can also or instead be applied to improve the driver's experience while driving. FIG. 25A schematically shows an example of vehicles 2500 and 2502 and AR content 2504 (e.g., a longitudinal line presented in a HUD image) with and without dynamic occlusion. The vehicles 2500 and 2502 are real vehicles that are located near the vehicle that has the HUD system, so that they are visible through the windshield. With the vehicle 2500, dynamic occlusion is not performed. The AR content 2504 therefore appears “on top of” the vehicle 2500 and the sense of realism in the HUD image is immediately lost for the driver. With the vehicle 2502, by contrast, dynamic occlusion is performed. The AR content 2504 therefore appears “behind” or “under” the vehicle 2502 from the driver's perspective. This allows the HUD system to maintain a sense of AR realism in the HUD image by cropping out objects in the foreground. For example, vehicles, pedestrians, etc. can be cropped out. This can be done based on perception signals of a driver assistance system (e.g., from an SVM camera).

FIG. 25B shows an example of a mask 2506 that can be used to provide the dynamic occlusion of FIG. 25A. The mask 2506 can be dynamically created (e.g., as a layer) to obscure objects positioned underneath. The shape of any object visible to a camera can be used to define a mask corresponding to that object. For example, if the mask 2506 is created based on, and applied on top of, the vehicle 2502, the portion of the AR content 2504 covered by the mask 2506 is not presented in (i.e., dynamically occluded from) the HUD image. The mask 2506 shall then move dynamically within the ARHUD display according to the camera feed and driver eye position to ensure continuous and realistic obscuration of moving objects.

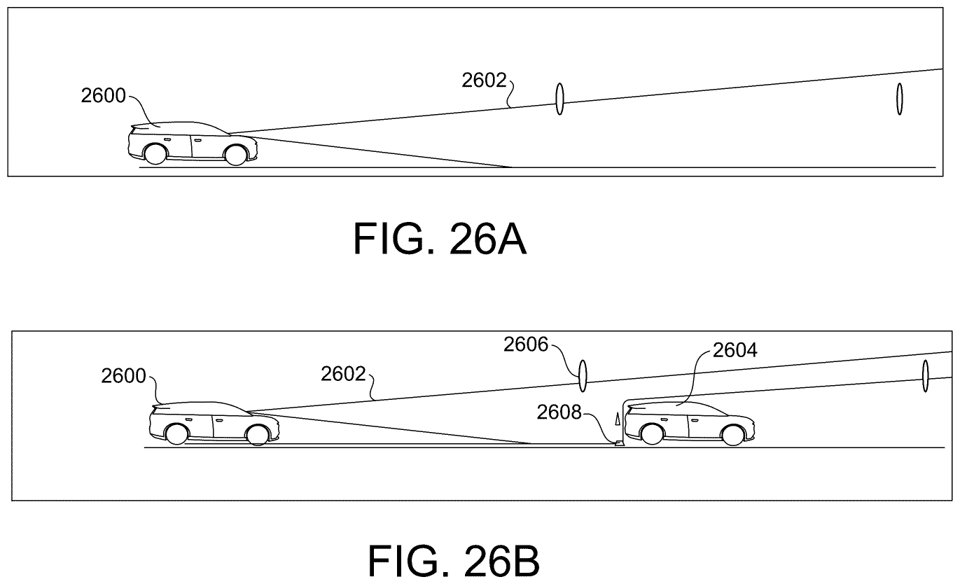

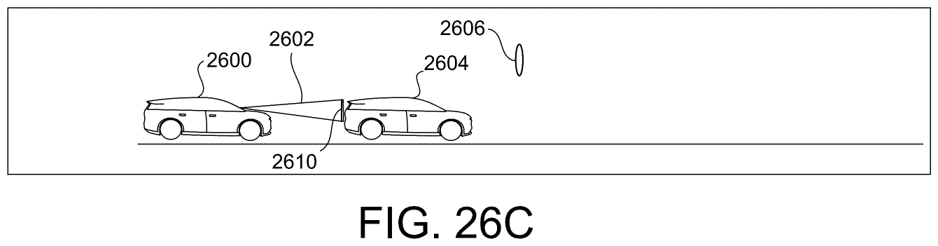

FIG. 26A schematically shows an example relating to switching between presenting AR content and a 2D view. A vehicle 2600 is currently traveling on a road and has a HUD system generating a HUD image that corresponds to a FOV 2602. Currently, no other vehicle or other object is present on the road within the FOV 2602 and there may not be any need to present AR content to the driver of the vehicle 2600.

FIG. 26B schematically shows another example relating to switching between presenting the AR content and the 2D view. Here, the vehicle 2600 and a vehicle 2604 are both traveling on the road. The vehicle 2604 is currently separated from the vehicle 2600 by more than a threshold distance 2606. The HUD system can therefore present one or more vehicle markers 2608 to indicate the presence of the vehicle 2604. For example, the one or more vehicle markers 2608 can be placed in a road surface AR plane and can be positioned immediately behind the vehicle 2604. That is, because the vehicle 2604 is not within the threshold distance 2606, the one or more vehicle markers 2608 (or other AR content for the vehicle 2604) can be placed as indicated and remain within the FOV 2602.

FIG. 26C schematically shows another example relating to switching between presenting the AR content and the 2D view. The vehicle 2604 is now close enough to the vehicle 2600 to block the FOV 2602. Therefore, the HUD system can switch from presenting AR content to instead presenting a 2D view 2610. For example, the 2D view 2610 can indicate the presence of the vehicle 2604 and the distance to it other than by using the vehicle marker 2608. That is, due to the necessary limitation of the FOV 2602, if objects are too close the HUD system cannot display AR elements in a meaningful or realistic way. A switch between AR content and 2D view can therefore be performed so that non-realistic AR content is not presented. A similar approach can be used when presenting navigation instructions: when no obstructing objects are within the threshold distance 2606, AR content can provide turn instructions; on the other hand, when an obstructing object is within the threshold distance 2606, turn instructions can instead be provided using the 2D view.

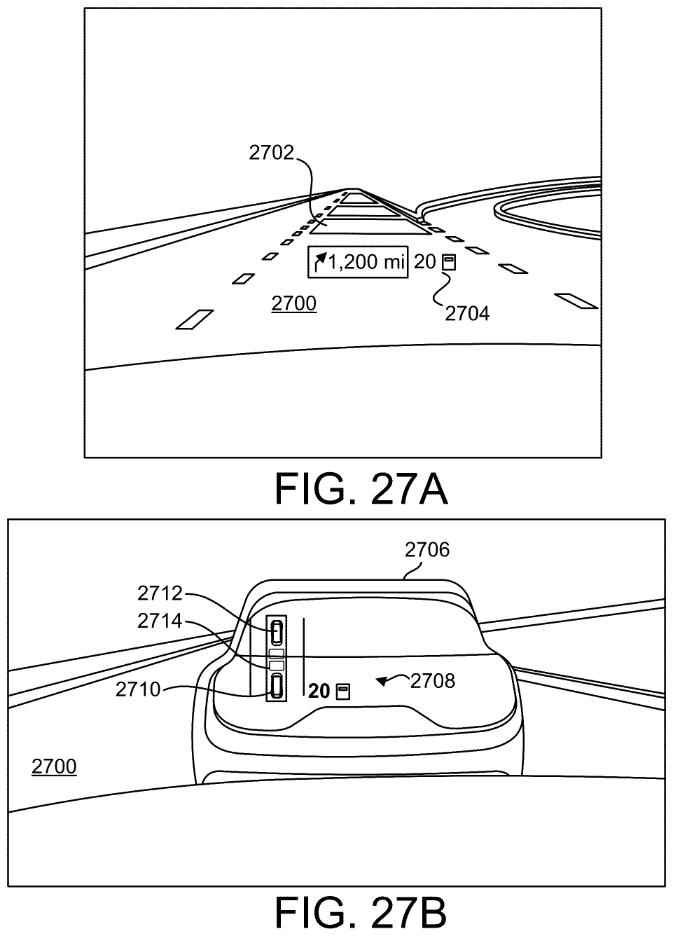

FIG. 27A schematically shows an example relating to switching between presenting AR content and a 2D view. This example in this illustration is analogous to the situation in FIG. 26B. A HUD image 2700 is presented in a vehicle traveling on a road. Because no other object is present within a horizon (e.g., threshold) distance in front of the vehicle, AR content 2702 can be presented in a realistic manner. In some implementations, the AR content 2702 can include distance markers to an object present beyond the threshold. For example, the AR content 2702 can be placed in a road surface AR plane of the HUD system. A 2D cluster 2704 can also be presented in the HUD image 2700.

FIG. 27B schematically shows another example relating to switching between presenting the AR content and the 2D view. Here, a vehicle 2706 is present within the threshold distance and would interfere with the AR content 2702 (FIG. 27A) if the AR content 2702 were presented. Rather, the HUD system switches to a 2D view including content 2708. For example, the content 2708 includes a representation 2710 of the driver's vehicle, a representation 2712 of the vehicle 2706, and one or more vertical distance markers 2714 representing the distance between the driver's vehicle and the vehicle 2706.

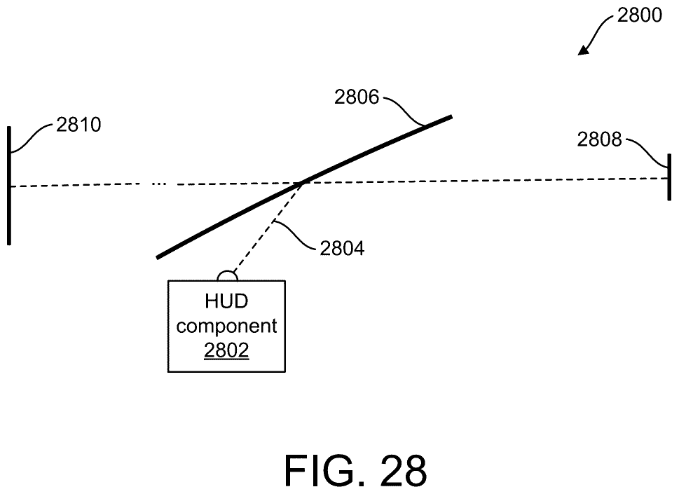

FIG. 28 shows an example of a HUD system 2800. The HUD system 2800 can be used in a vehicle to assist a driver using AR content. The HUD system 2800 is schematically illustrated, viewed generally from the side of the vehicle, to illustrate the main components. The HUD system 2800 includes a HUD component 2802. The HUD component 2802 can include the optical and processing components necessary to define HUD images and project them. For example, the HUD component 2802 includes a picture generating unit (PGU) that provides illumination and image content, and one or more lenses and/or mirrors. The PGU can include a light source based on one or more illumination techniques. In some implementations, the PGU provides illumination using one or more light emitting diodes (LEDs). For example, LEDs of multiple colors (e.g., red, green, blue) can be provided. In some implementations, the PGU can generate an image using a liquid crystal on silicon (LCOS) projector. One or more other approaches can be used, including but not limited to a digital micromirror device (DMD) and/or a microelectronic mechanical system (MEMS) projector. For example, the PGU can use one or more optical elements, including but not limited to, a lens and/or mirror, between the light source and the LCOS/DMD/MEMS device, and/or elsewhere.

The HUD component 2802 can project light 2804 that when reflected by a windshield 2806 and then observed by an occupant (here represented by an eye box 2808) creates the appearance of a virtual image 2810 for the occupant. The virtual image 2810 can be characterized as being located at a virtual image distance (VID) from the eye box 2808. Having a significant VID can be beneficial to allow the occupant to see the content generated by the HUD system 2800 (i.e., the virtual image 2810) with no or only minor refocusing from observing objects in traffic or otherwise near the vehicle. This can allow the virtual image 2810 to practically blend into the surroundings from the occupant's perspective.

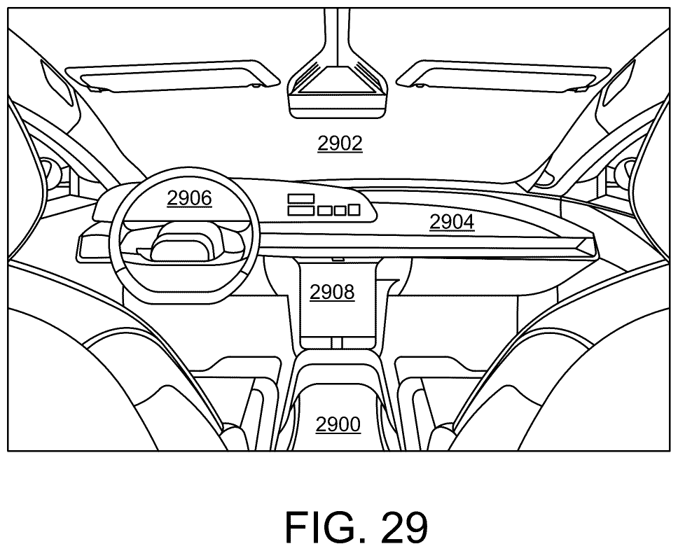

FIG. 29 shows an example of a passenger compartment 2900 of a vehicle with a windshield 2902 where a HUD image can be presented. The passenger compartment 2900 can include an instrument panel 2904 that forms a boundary for the windshield 2902. A HUD system can be positioned on, or be partially or fully embedded inside, the instrument panel 2904. The HUD image presented on the windshield 2902 (e.g., any HUD image exemplified elsewhere herein) can be used in lieu of, or together with, one or more display devices. For example, the instrument panel 2904 can include a display device 2906 (e.g., an instrument cluster) and/or a display device 2908 (e.g., a center display). Other approaches can be used.

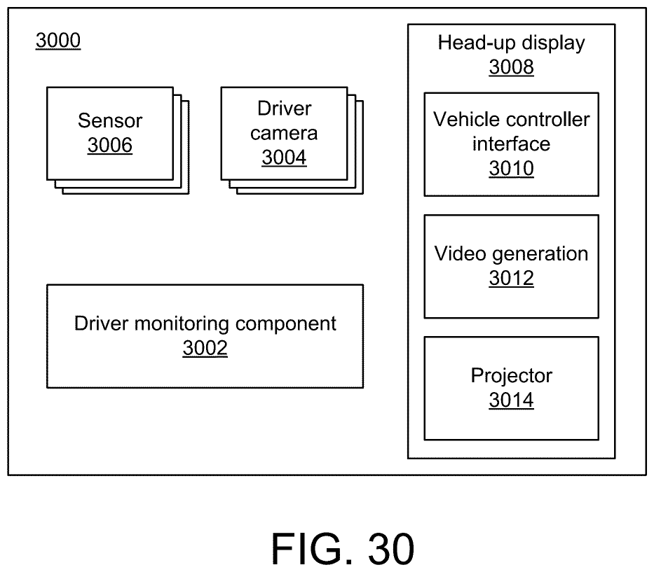

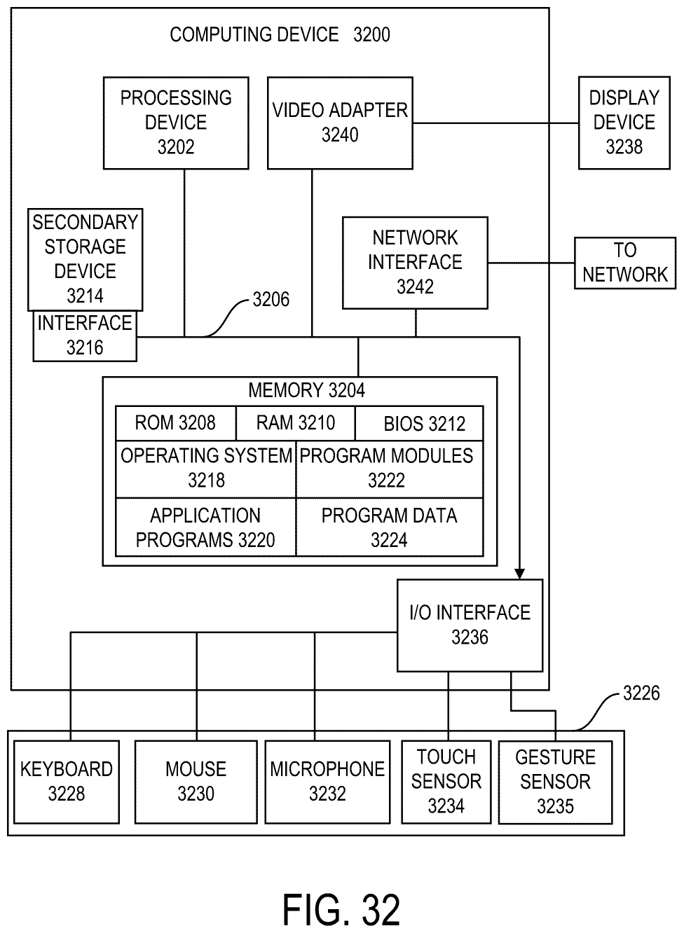

FIG. 30 shows an example of a driver assistance system 3000. The driver assistance system 3000 can be implemented using one or more aspects described below with reference to FIG. 32. For example, components can be implemented by one or more processors executing instructions stored in a computer-readable medium.

The driver assistance system 3000 includes an occupant monitoring component 3002 that processes an output of the one or more driver cameras 3004. In some implementations, the driver camera 3004 includes the camera 206 of FIG. 2. For example, the occupant monitoring component 3002 can generate an output (e.g., a reminder or alert) and/or take corrective action depending on the result of the driver monitoring. In some implementations, the occupant monitoring component 3002 can analyze image output of the one or more driver cameras 3004 to detect whether the driver is distracted or inattentive (e.g., by directing their attention elsewhere than on controlling the vehicle). The occupant monitoring component 3002 can perform eye tracking or any other monitoring.

The driver assistance system 3000 can receive input (e.g., one or more type of signals) from any of a plurality of sensors 3006. Any of the sensors 3006 can be external to the vehicle (e.g., a camera, LiDAR, radar, or an ultrasonic sensor) or internal to the vehicle.

The driver assistance system 3000 can include a HUD system 3008. The HUD system 3008 can include a vehicle controller interface 3010 (e.g., to receive information to be presented in the HUD from a vehicle controller). The HUD system 3008 can include a video generation component 3012 (e.g., to dynamically generate image content for the HUD system). The HUD system 3008 can include a projector 3014 (e.g., to project and update the HUD image on a windshield). For example, the vehicle controller interface 3010 can facilitate interaction with a navigation system of the vehicle in which is defined navigation instructions for guiding the vehicle through a defined travel route; the video generation component 3012 can generate image content (e.g., any of the AR contents exemplified elsewhere herein) based communication from the vehicle controller interface 3010; and the projector 3014 can display the generated image on the vehicle windshield.

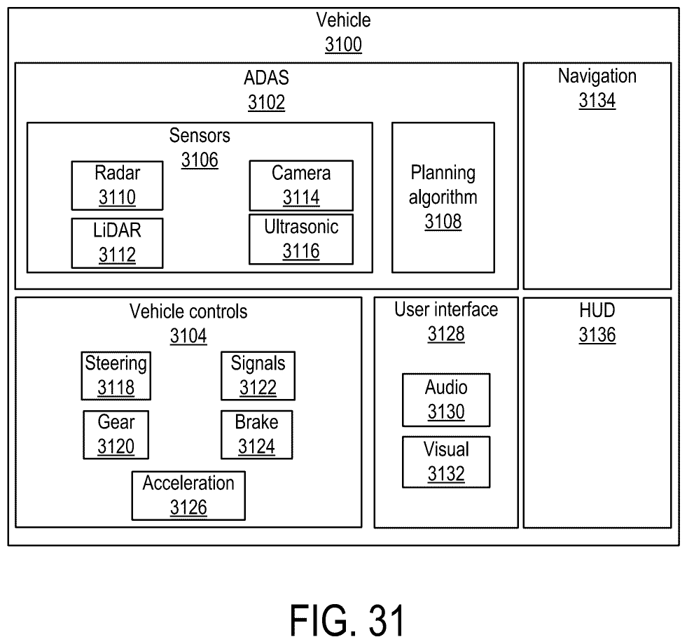

FIG. 31 shows an example of a vehicle. The vehicle 3100 includes an advanced driver assistance system (ADAS) 3102 and vehicle controls 3104. The ADAS 3102 can be implemented using some or all components described with reference to FIG. 32 below. The ADAS 3102 includes sensors 3106 and a planning algorithm 3108. Other aspects that the vehicle 3100 may include, including, but not limited to, other components of the vehicle 3100 where the ADAS 3102 may be implemented, are omitted here for simplicity.

The sensors 3106 are here described as also including appropriate circuitry and/or executable programming for processing sensor output and performing a detection based on the processing. The sensors 3106 can include a radar 3110. In some implementations, the radar 3110 can include any object detection system that is based at least in part on radio waves. For example, the radar 3110 can be oriented in a forward direction relative to the vehicle and can be used for detecting at least a distance to one or more other objects (e.g., another vehicle). The radar 3110 can detect the surroundings of the vehicle 3100 by sensing the presence of an object in relation to the vehicle 3100.

The sensors 3106 can include an active light sensor 3112. In some implementations, the active light sensor 3112 can include any object detection system that is based at least in part on laser light. The active light sensor 3112 can include a scanning LiDAR or a non-scanning LiDAR (e.g., a flash LiDAR), to name just two examples. The active light sensor 3112 can be used for detecting at least a distance to one or more other objects (e.g., a lane boundary). The active light sensor 3112 can detect the surroundings of the vehicle 3100 by sensing the presence of an object in relation to the vehicle 3100.

The sensors 3106 can include a camera 3114. In some implementations, the camera 3114 can include any image sensor whose signal(s) the vehicle 3100 takes into account. For example, the camera 3114 can be oriented in any direction relative to the vehicle and can be used for detecting vehicles, lanes, lane markings, curbs, and/or road signage. The camera 3114 can detect the surroundings of the vehicle 3100 by visually registering a circumstance in relation to the vehicle 3100.

The sensors 3106 can include an ultrasonic sensor 3116. In some implementations, the ultrasonic sensor 3116 can include any transmitter, receiver, and/or transceiver used in detecting at least the proximity of an object based on ultrasound. For example, the ultrasonic sensor 3116 can be positioned at or near an outer surface of the vehicle. The ultrasonic sensor 3116 can detect the surroundings of the vehicle 3100 by sensing the presence of an object in relation to the vehicle 3100.

Any of the sensors 3106 alone, or two or more of the sensors 3106 collectively, can detect, whether or not the ADAS 3102 is controlling motion of the vehicle 3100, the surroundings of the vehicle 3100. In some implementations, at least one of the sensors 3106 can generate an output that is taken into account in providing an instruction, alert or other prompt to a driver, and/or in controlling motion of the vehicle 3100. For example, the output of one or more sensors (e.g., the outputs of the radar 3110, the active light sensor 3112, or the camera 3114) can be combined. In some implementations, one or more other types of sensors can additionally or instead be included in the sensors 3106.

The planning algorithm 3108 can plan for the ADAS 3102 to perform one or more actions, or to not perform any action, in response to monitoring of the surroundings of the vehicle 3100 and/or an input by the driver. The output of one or more of the sensors 3106 can be taken into account. In some implementations, the planning algorithm 3108 can perform motion planning and/or plan a trajectory for the vehicle 3100.

The vehicle controls 3104 can include a steering control 3118. In some implementations, the ADAS 3102 and/or another driver of the vehicle 3100 controls the trajectory of the vehicle 3100 by adjusting a steering angle of at least one wheel by way of manipulating the steering control 3118. The steering control 3118 can be configured for controlling the steering angle though a mechanical connection between the steering control 3118 and the adjustable wheel, or can be part of a steer-by-wire system.

The vehicle controls 3104 can include a gear control 3120. In some implementations, the ADAS 3102 and/or another driver of the vehicle 3100 uses the gear control 3120 to choose from among multiple operating modes of a vehicle (e.g., a Drive mode, a Neutral mode, or a Park mode). For example, the gear control 3120 can be used to control an automatic transmission in the vehicle 3100.

The vehicle controls 3104 can include signal controls 3122. In some implementations, the signal controls 3122 can control one or more signals that the vehicle 3100 can generate. For example, the signal controls 3122 can control headlights, a turn signal and/or a horn of the vehicle 3100.

The vehicle controls 3104 can include brake controls 3124. In some implementations, the brake controls 3124 can control one or more types of braking systems designed to slow down the vehicle, stop the vehicle, and/or maintain the vehicle at a standstill when stopped. For example, the brake controls 3124 can be actuated by the ADAS 3102. As another example, the brake controls 3124 can be actuated by the driver using a brake pedal.

The vehicle controls 3104 can include an acceleration control 3126. In some implementations, the acceleration control 3126 can control one or more types of propulsion motor of the vehicle. For example, the acceleration control 3126 can control the electric motor(s) and/or the internal-combustion motor(s) of the vehicle 3100.

The vehicle 3100 can include a user interface 3128. The user interface 3128 can include an audio interface 3130 that can be used for generating an alert regarding a detection. In some implementations, the audio interface 3130 can include one or more speakers positioned in the passenger compartment. For example, the audio interface 3130 can at least in part operate together with an infotainment system in the vehicle.

The user interface 3128 can include a visual interface 3132 that can be used for generating an alert regarding a detection. In some implementations, the visual interface 3132 can include at least one display device in the passenger compartment of the vehicle 3100. For example, the visual interface 3132 can include a touchscreen device and/or an instrument cluster display.

The vehicle 3100 can include a navigation system 3134. The navigation system 3134 can receive input from a user and generate navigation instructions in response. For example, the user can input a specific destination (e.g., by entering a street address or geocoordinates), or the user can choose a destination that the navigation system navigation system 3134 presents to the user (e.g., in response to the user searching for travel destinations). The navigation instructions can be generated in any form that can be handled by the vehicle 3100 (e.g., by a HUD system) for outputting human-understandable guidance to the driver. For example, the navigation instructions can support GPS turn-by-turn navigation.

The vehicle 3100 can include a HUD system 3136. The HUD system 3136 can support generation and presentation of any or all of the HUD images exemplified here. For example, the HUD system 3136 can be the HUD system 3008 of FIG. 30.

FIG. 32 illustrates an example architecture of a computing device 3200 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 32 can be used to execute the operating system, application programs, and/or software modules (including the software engines) described herein.

The computing device 3200 includes, in some embodiments, at least one processing device 3202 (e.g., a processor), such as a central processing unit (CPU). A variety of processing devices are available from a variety of manufacturers, for example, Intel or Advanced Micro Devices. In this example, the computing device 3200 also includes a system memory 3204, and a system bus 3206 that couples various system components including the system memory 3204 to the processing device 3202. The system bus 3206 is one of any number of types of bus structures that can be used, including, but not limited to, a memory bus, or memory controller; a peripheral bus; and a local bus using any of a variety of bus architectures.

Examples of computing devices that can be implemented using the computing device 3200 include a desktop computer, a laptop computer, a tablet computer, a mobile computing device (such as a smart phone, a touchpad mobile digital device, or other mobile devices), or other devices configured to process digital instructions.

The system memory 3204 includes read only memory 3208 and random access memory 3210. A basic input/output system 3212 containing the basic routines that act to transfer information within computing device 3200, such as during start up, can be stored in the read only memory 3208.

The computing device 3200 also includes a secondary storage device 3214 in some embodiments, such as a hard disk drive, for storing digital data. The secondary storage device 3214 is connected to the system bus 3206 by a secondary storage interface 3216. The secondary storage device 3214 and its associated computer readable media provide nonvolatile and non-transitory storage of computer readable instructions (including application programs and program modules), data structures, and other data for the computing device 3200.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 3214 and/or system memory 3204, including an operating system 3218, one or more application programs 3220, other program modules 3222 (such as the software engines described herein), and program data 3224. The computing device 3200 can utilize any suitable operating system.

In some embodiments, a user provides inputs to the computing device 3200 through one or more input devices 3226. Examples of input devices 3226 include a keyboard 3228, mouse 3230, microphone 3232 (e.g., for voice and/or other audio input), touch sensor 3234 (such as a touchpad or touch sensitive display), and gesture sensor 3235 (e.g., for gestural input). In some implementations, the input device(s) 3226 provide detection based on presence, proximity, and/or motion. Other embodiments include other input devices 3226. The input devices can be connected to the processing device 3202 through an input/output interface 3236 that is coupled to the system bus 3206. These input devices 3226 can be connected by any number of input/output interfaces, such as a parallel port, serial port, game port, or a universal serial bus. Wireless communication between input devices 3226 and the input/output interface 3236 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 3238, such as a monitor, liquid crystal display device, light-emitting diode display device, projector, or touch sensitive display device, is also connected to the system bus 3206 via an interface, such as a video adapter 3240. In addition to the display device 3238, the computing device 3200 can include various other peripheral devices (not shown), such as speakers or a printer.

The computing device 3200 can be connected to one or more networks through a network interface 3242. The network interface 3242 can provide for wired and/or wireless communication. In some implementations, the network interface 3242 can include one or more antennas for transmitting and/or receiving wireless signals. When used in a local area networking environment or a wide area networking environment (such as the Internet), the network interface 3242 can include an Ethernet interface. Other possible embodiments use other communication devices. For example, some embodiments of the computing device 3200 include a modem for communicating across the network.

The computing device 3200 can include at least some form of computer readable media. Computer readable media includes any available media that can be accessed by the computing device 3200. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 3200.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 32 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 3200 can be characterized as an ADAS computer. For example, the computing device 3200 can include one or more components sometimes used for processing tasks that occur in the field of artificial intelligence (AI). The computing device 3200 then includes sufficient proceeding power and necessary support architecture for the demands of ADAS or AI in general. For example, the processing device 3202 can include a multicore architecture. As another example, the computing device 3200 can include one or more co-processors in addition to, or as part of, the processing device 3202. In some implementations, at least one hardware accelerator can be coupled to the system bus 3206. For example, a graphics processing unit can be used. In some implementations, the computing device 3200 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
generating, by a navigation system of a vehicle, at least one navigation instruction to instruct a driver of the vehicle to make a turn at a location;
presenting, using a head-up display (HUD) system of the vehicle, a HUD image on a windshield of the vehicle, the HUD image comprising augmented reality (AR) content including i) a turn symbol corresponding to the turn, and ii) a countdown indicator at least partially surrounding the turn symbol;
updating the HUD image, before the vehicle reaches the location, so that the countdown indicator indicates a remaining time until the vehicle reaches the location; and
updating the HUD image, after the vehicle reaches the location, so that the turn symbol rotates to indicate a direction of the turn.

2. (canceled)

3. (canceled)

4. (canceled)

5. (canceled)

6. (canceled)

7. The method of claim 1, wherein the turn symbol and the countdown indicator are positioned in a vertical AR plane of the HUD image, the HUD image further including a road surface AR plane that is substantially perpendicular to the vertical AR plane.

8. The method of claim 7, further comprising presenting a grounding element in the road surface AR plane, wherein the grounding element corresponds to the turn symbol and the countdown indicator.

9. The method of claim 8, wherein the grounding element consists of a grounding dot in the road surface AR plane.

10. The method of claim 7, further comprising presenting AR distance markers in the road surface AR plane.

11. The method of claim 10, wherein while the AR distance markers are presented in the road surface AR plane a leading vehicle appears in front of the vehicle, the method further comprising switching from presenting the AR distance markers to instead presenting a two-dimensional (2D) view in the vertical AR plane, the 2D view including representations of the vehicle and the leading vehicle, and vertical distance markers between the representations of the vehicle and the leading vehicle.

12. (canceled)

13. (canceled)

14. (canceled)

15. (canceled)

16. (canceled)

17. (canceled)

18. (canceled)

19. (canceled)

20. (canceled)

21. (canceled)

22. The method of claim 1, further comprising presenting longitudinal lines in the HUD image, the longitudinal lines indicating a width of the vehicle.

23. The method of claim 22, further comprising dynamically occluding at least a portion of the longitudinal lines based on presence of a first object in front of the vehicle.

24. The method of claim 23, wherein dynamically occluding the portion of the longitudinal lines comprises:
dynamically creating a mask corresponding to a shape of the first object; and
occluding the portion of the longitudinal lines using the mask, wherein the portion of the longitudinal lines is not visible in the HUD image.

25. The method of claim 22, further comprising:
detecting presence of a second object is positioned across at least one of the longitudinal lines; and
in response to the detection, changing a color of the at least one of the longitudinal lines to indicate the presence of the second object.

26. (canceled)

27. (canceled)

28. (canceled)

29. (canceled)

30. (canceled)

31. A method comprising:
generating, by a navigation system of a vehicle, at least one navigation instruction to instruct a driver of the vehicle to make a turn at a location;
presenting, using a head-up display (HUD) system of the vehicle, a HUD image on a windshield of the vehicle, the HUD image comprising augmented reality (AR) content including a turn symbol corresponding to the turn; and
updating the HUD image, after the vehicle reaches the location, to also include a target symbol, wherein the turn symbol remains stationary on the windshield, and wherein the target symbol moves in a substantially horizontal direction on the windshield to indicate a target of the turn.

32. (canceled)

33. (canceled)

34. (canceled)

35. The method of claim 31, further comprising presenting a countdown indicator in the HUD image, the countdown indicator at least partially surrounding the turn symbol.

36. The method of claim 35, wherein the countdown indicator comprises a circular progress bar.

37. The method of claim 35, wherein updating the HUD image before the vehicle reaches the location comprises including progressively more details in the AR content as the vehicle approaches the location.

38. The method of claim 37, wherein initially the AR content includes only the countdown indicator and not the turn symbol, and wherein updating the HUD image before the vehicle reaches the location further comprises adding the turn symbol to the AR content.

39. (canceled)

40. The method of claim 31, wherein the turn symbol and the target symbol are positioned in a vertical AR plane of the HUD image, the HUD image further including a road surface AR plane that is substantially perpendicular to the vertical AR plane.

41. The method of claim 40, further comprising presenting a grounding element in the road surface AR plane, wherein the grounding element corresponds to the turn symbol.

42. The method of claim 41, wherein the grounding element consists of a grounding dot in the road surface AR plane.

43. The method of claim 40, further comprising presenting AR distance markers in the road surface AR plane.

44. The method of claim 43, wherein while the AR distance markers are presented in the road surface AR plane a leading vehicle appears in front of the vehicle, the method further comprising switching from presenting the AR distance markers to instead presenting a two-dimensional (2D) view in the vertical AR plane, the 2D view including representations of the vehicle and the leading vehicle, and vertical distance markers between the representations of the vehicle and the leading vehicle.

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)
